(19) United States
(12) Patent Application Publication
(10) Pub. No.: US 2024/0116140 A1
(43) Pub. Date: Apr. 11, 2024

(54) LOW NUMERICAL APERTURE OPTICS TO ENABLE LASER CUTTING OF TEXTURED SUBSTRATES

(71) Applicant: CORNING INCORPORATED, Corning, NY (US)

(72) Inventors: Sterling Michael Clarke, Corning, NY (US); Reinhard Moritz Malchus, Munich (DE); Sasha Marjanovic, Painted Post, NY (US); Garrett Andrew Piech, Corning, NY (US); Alranzo Boh Ruffin, Painted Post, NY (US); Sergio Tsuda, Horseheads, NY (US)

(21) Appl. No.: 18/374,068

(22) Filed: Sep. 28, 2023

Related U.S. Application Data
(60) Provisional application No. 63/501,865, filed on May 12, 2023.
(60) Provisional application No. 63/412,826, filed on Oct. 3, 2022.

(51) Int. Cl. B23K 26/53; B23K 26/40

(52) U.S. Cl. CPC B23K 26/53; B23K 26/40; B23K 2103/54

(57) ABSTRACT

A method of processing a transparent workpiece comprises directing a defect-forming laser beam to an impingement surface of a transparent workpiece, the defect-forming laser beam having a numerical aperture from 0.10 to 0.25, the transparent workpiece having a textured surface, the textured surface having an Ra value of greater than or equal to 0.5 μm.

This application claims the benefit of priority under 35 U.S.C § 120 of U.S. Provisional Application Ser. No. 63/501,865 filed on May 12, 2023 and U.S. Provisional Application Ser. No. 63/412,826 filed on Oct. 3, 2022, the contents of which are relied upon and incorporated herein by reference in their entirety.

### BACKGROUND

### Field

The present specification generally relates to apparatuses and methods for laser processing transparent workpieces.

### Technical Background

Advancements in precision micromachining and related process improvements made to reduce size, weight and material costs have facilitated fast-paced growth of products such as, but not limited to, flat panel displays for touch screens, tablets, smartphones, and televisions. As a result of these advancements, ultrafast pulsed industrial lasers have become important tools for applications requiring high precision micromachining. Laser cutting processes utilizing such lasers are expected to separate substrates in a controllable fashion, to form negligible debris and low subsurface damage to the substrate. Surface texture of a substrate can reduce the effectiveness of laser cutting processes. For example, surface texture may scatter or distort a laser beam, preventing the laser beam from possessing adequate energy density to modify the substrate through the substrate's entire thickness. Additionally, separation of the textured substrate may form unacceptable amounts of debris and also may cause subsurface damage to the separated portions of the substrate.

### SUMMARY

A first aspect of the present disclosure includes a method of processing a transparent workpiece comprises directing a defect-forming laser beam to an impingement surface of a transparent workpiece, the defect-forming laser beam having a numerical aperture from 0.10 to 0.25, the transparent workpiece having a textured surface, the textured surface having an Ra value of greater than or equal to 0.5 μm.

Additional features and advantages of the processes and systems described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts conventional mechanical score and break laser cutting;

FIG. 2 schematically depicts a comparison of laser cutting with a Gaussian beam focus versus laser cutting with a Bessel-like beam focus;

FIG. 3 schematically depicts the formation of a contour of defects in a transparent workpiece with a textured surface, according to one or more embodiments described herein;

FIG. 4 schematically depicts an example pulsed laser beam focal line during processing of the transparent workpiece, according to one or more embodiments described herein;

FIG. 5 schematically depicts an optical assembly for laser processing with pulsed laser beam focal lines, according to one or more embodiments described herein;

FIG. 6 graphically depicts the relative intensity of laser pulses within an example pulse burst vs. time, according to one or more embodiments described herein;

FIG. 7 schematically depicts an optical beam focused by an axicon, according to one or more embodiments described herein;

FIG. 8 depicts a cross-sectional profile of a Bessel-like beam formed by an axicon, according to one or more embodiments described herein;

FIG. 9 graphically depicts on-axis intensity of a Gauss-Bessel beam as a function of distance along the optical axis, according to one or more embodiments described herein;

FIG. 10 schematically depicts an optical setup that creates a line focus by using a telescope to relay and magnify the image of a line focus first formed by an axicon, according to one or more embodiments described herein;

FIG. 11 schematically depicts an optical setup with an additional magnifying telescope of magnification N placed before the axicon, according to one or more embodiments described herein;

FIG. 12 schematically depicts an optical assembly for laser processing with an infrared laser beam, according to one or more embodiments described herein;

FIG. 13 schematically depicts the infrared laser beam depicted in FIG. 4A incident on a textured surface of a transparent workpiece, according to one or more embodiments described herein;

FIG. 14 schematically depicts a transparent workpiece comprising a plurality of defects extending along a contour and a line of separation, according to one or more embodiments described herein;

FIG. 15 schematically depicts a separated portion of a transparent workpiece at a cut edge, according to one or more embodiments described herein;

FIG. 16 depicts a view of a transparent workpiece with a textured surface that is separated along a curved contour, according to one or more embodiments described herein;

FIG. 17 depicts a view of nano-perforations used to define the separation of a glass sheet into discrete pieces, and subsequent separation of the glass pieces after application of stress (e.g., mechanical or thermal stress), according to one or more embodiments described herein;

FIG. 18 depicts a view of a separated edge of a 700 μm thick glass sheet cut with the nano-perforation process, with each vertical striation being an individual nano-perforation, according to one or more embodiments described herein;

FIG. 19 depicts an example of using an asymmetric quasi-non-diffracting beam to nano-perforate a radiused part corner, according to one or more embodiments described herein;

FIG. 20 depicts a comparison of the nano-perforated and separated edges of a glass sheet, where the nano-perforation has been strong through the full thickness of the sheet (top image) and where the nano-perforation has been weak or incomplete near the bottom of the glass sheet (bottom image), according to one or more embodiments described herein;

FIG. 21 depicts a nano-perforated and separated glass edge in the region of a radiused corner of a part;

FIG. 22 are microscope images of textured glass articles, according to one or more embodiments shown and described herein;

FIG. 23 are microscope images of textured glass articles, according to one or more embodiments shown and described herein;

FIG. 24 are microscope images of textured glass articles, according to one or more embodiments shown and described herein;

FIG. 25 are interferometric roughness characterization images of the surface of textured glass articles, according to one or more embodiments shown and described herein;

FIG. 26 depicts an example of nano-perforation of a textured glass sheet, according to one or more embodiments shown and described herein;

FIG. 27 depicts an example of nano-perforation of a textured glass sheet, according to one or more embodiments shown and described herein;

FIG. 28 depicts an example of a “cantilever curl”;

FIG. 29 depicts textured glass sheets nano-perforated using two passes and at different focus heights;

FIG. 30 depicts an edge view of nano-perforated and separated glass sheets where the surface of the glass was mechanically polished before laser exposure;

FIG. 31 depicts description of conditions used when modeling a NA=0.37 Gauss-Bessel beam incident on a textured piece of glass;

FIG. 32 depicts a model of the distortion of a NA=0.37 Gauss-Bessel beam incident on a glass surface with periodic height deformations of 0.125 μm amplitude;

FIG. 33 depicts a model of the distortion of a NA=0.37 Gauss-Bessel beam incident on a glass surface with periodic height deformations of 5 μm amplitude;

FIG. 34 graphically depicts a model of the distortion of a NA=0.37 Gauss-Bessel beam incident on a glass surface with surface distortion of varying amplitude and constant pitch;

FIG. 35 graphically depicts a model of the distortion of a NA=0.37 Gauss-Bessel beam incident on a glass surface with surface distortion of varying amplitude and constant pitch;

FIG. 36 graphically depicts a model of the distortion of a NA=0.37 Gauss-Bessel beam incident on a glass surface with surface distortion of varying amplitude and constant pitch;

FIG. 37 graphically depicts a model of the distortion of a NA=0.37 Gauss-Bessel beam incident on a glass surface with surface distortion of varying amplitude and constant pitch;

FIG. 38 graphically depicts a model of the distortion of a NA=0.37 Gauss-Bessel beam incident on a glass surface with surface distortion of varying amplitude and constant pitch;

FIG. 39A depicts a model of the cross-sectional intensity of a Gauss-Bessel beam with NA=0.15 vs. propagation distance along the optical axis, propagating in only air;

FIG. 39B depicts a model of the cross-sectional intensity of a Gauss-Bessel beam with NA=0.16 vs. propagation distance along the optical axis, propagating in only air;

FIG. 39C depicts a model of the cross-sectional intensity of a Gauss-Bessel beam with NA=0.18 vs. propagation distance along the optical axis, propagating in only air;

FIG. 39D depicts a model of the cross-sectional intensity of a Gauss-Bessel beam with NA=0.21 vs. propagation distance along the optical axis, propagating in only air;

FIG. 39E depicts a model of the cross-sectional intensity of a Gauss-Bessel beam with NA=0.26 vs. propagation distance along the optical axis, propagating in only air;

FIG. 40A shows the modeled on-axis intensity of the Gauss Bessel beam of FIG. 39A vs. propagation distance along the optical axis;

FIG. 40B shows the modeled on-axis intensity of the Gauss Bessel beam of FIG. 39B vs. propagation distance along the optical axis;

FIG. 40C shows the modeled on-axis intensity of the Gauss Bessel beam of FIG. 3C vs. propagation distance along the optical axis;

FIG. 40D shows the modeled on-axis intensity of the Gauss Bessel beam of FIG. 39D vs. propagation distance along the optical axis;

FIG. 40E shows the modeled on-axis intensity of the Gauss Bessel beam of FIG. 39E vs. propagation distance along the optical axis;

FIG. 41A a model of the cross-sectional intensity of a Gauss-Bessel beam with NA=0.15 vs. propagation distance along the optical axis, interacting with a flat glass substrate;

FIG. 41B a model of the cross-sectional intensity of a Gauss-Bessel beam with NA=0.16 vs. propagation distance along the optical axis, interacting with a flat glass substrate;

FIG. 41C a model of the cross-sectional intensity of a Gauss-Bessel beam with NA=0.18 vs. propagation distance along the optical axis, interacting with a flat glass substrate;

FIG. 41D a model of the cross-sectional intensity of a Gauss-Bessel beam with NA=0.21 vs. propagation distance along the optical axis, interacting with a flat glass substrate;

FIG. 41E a model of the cross-sectional intensity of a Gauss-Bessel beam with NA=0.26 vs. propagation distance along the optical axis, interacting with a flat glass substrate;

FIG. 42A shows the modeled on-axis intensity of the Gauss Bessel beam of FIG. 41A vs. propagation distance along the optical axis;

FIG. 42B shows the modeled on-axis intensity of the Gauss Bessel beam of FIG. 41B vs. propagation distance along the optical axis;

FIG. 42C shows the on-axis intensity of the Gauss Bessel beam of FIG. 41C vs. propagation distance along the optical axis;

FIG. 42D shows the modeled on-axis intensity of the Gauss Bessel beam of FIG. 41D vs. propagation distance along the optical axis;

FIG. 42E shows the modeled on-axis intensity of the Gauss Bessel beam of FIG. 41E vs. propagation distance along the optical axis;

FIG. 43A a model of the cross-sectional intensity of a Gauss-Bessel beam with NA=0.15 vs. propagation distance along the optical axis, interacting with a textured glass substrate;

FIG. 43B a model of the cross-sectional intensity of a Gauss-Bessel beam with NA=0.16 vs. propagation distance along the optical axis, interacting with a textured glass substrate;

FIG. 43C a model of the cross-sectional intensity of a Gauss-Bessel beam with NA=0.18 vs. propagation distance along the optical axis, interacting with a textured glass substrate;

FIG. 43D a model of the cross-sectional intensity of a Gauss-Bessel beam with NA=0.21 vs. propagation distance along the optical axis, interacting with a textured glass substrate;

FIG. 43E a model of the cross-sectional intensity of a Gauss-Bessel beam with NA=0.26 vs. propagation distance along the optical axis, interacting with a textured glass substrate;

FIG. 44A shows the modeled on-axis intensity of the Gauss Bessel beam of FIG. 43A vs. propagation distance along the optical axis;

FIG. 44B shows the modeled on-axis intensity of the Gauss Bessel beam of FIG. 43B vs. propagation distance along the optical axis;

FIG. 44C shows the modeled on-axis intensity of the Gauss Bessel beam of FIG. 43C vs. propagation distance along the optical axis;

FIG. 44D shows the modeled on-axis intensity of the Gauss Bessel beam of FIG. 43D vs. propagation distance along the optical axis;

FIG. 44E shows the modeled on-axis intensity of the Gauss Bessel beam of FIG. 43E vs. propagation distance along the optical axis;

FIG. 45 graphically depicts the length of the Gauss-Bessel beam shown in FIGS. 44A-44E, characterized by the full width at half-maximum of the on-axis beam intensity, as a function of numerical aperture;

FIG. 46A depicts a model of the cross-sectional intensity of a Gauss-Bessel beam with NA=0.15 vs. propagation distance along the optical axis, interacting with a textured glass surface having an amplitude of 5 μm*(Sin(2x)+Sin(2y))⁶ and a lateral offset (i.e., y-shift) of 0.0 mm;

FIG. 46B depicts a model of the cross-sectional intensity of a Gauss-Bessel beam with NA=0.16 vs. propagation distance along the optical axis, interacting with a textured glass surface having an amplitude of 5 μm*(Sin(2x)+Sin(2y))⁶ and a lateral offset (i.e., y-shift) of 0.0 mm;

FIG. 46C depicts a model of the cross-sectional intensity of a Gauss-Bessel beam with NA=0.18 vs. propagation distance along the optical axis, interacting with a textured glass surface having an amplitude of 5 μm*(Sin(2x)+Sin(2y))⁶ and a lateral offset (i.e., y-shift) of 0.0 mm;

FIG. 46D depicts a model of the cross-sectional intensity of a Gauss-Bessel beam with NA=0.21 vs. propagation distance along the optical axis, interacting with a textured glass surface having an amplitude of 5 μm*(Sin(2x)+Sin(2y))⁶ and a lateral offset (i.e., y-shift) of 0.0 mm;

FIG. 46E depicts a model of the cross-sectional intensity of a Gauss-Bessel beam with NA=0.26 vs. propagation distance along the optical axis, interacting with a textured glass surface having an amplitude of 5 μm*(Sin(2x)+Sin(2y))⁶ and a lateral offset (i.e., y-shift) of 0.0 mm;

FIG. 47A shows the modeled on-axis intensity of the Gauss Bessel beam of FIG. 46A vs. propagation distance along the optical axis;

FIG. 47B shows the modeled on-axis intensity of the Gauss Bessel beam of FIG. 46B vs. propagation distance along the optical axis;

FIG. 47C shows the modeled on-axis intensity of the Gauss Bessel beam of FIG. 46C vs. propagation distance along the optical axis;

FIG. 47D shows the modeled on-axis intensity of the Gauss Bessel beam of FIG. 46D vs. propagation distance along the optical axis;

FIG. 47E shows the modeled on-axis intensity of the Gauss Bessel beam of FIG. 46E vs. propagation distance along the optical axis;

FIG. 48 graphically depicts the length of the Gauss-Bessel beam shown in FIGS. 47A-47E, characterized by the full width at half-maximum of the on-axis beam intensity, as a function of numerical aperture;

FIG. 49A depicts a model of the cross-sectional intensity of a Gauss-Bessel beam with NA=0.15 vs. propagation distance along the optical axis, interacting with a textured glass surface having an amplitude of 5 μm*(Sin(2x)+Sin(2y))⁶ and a lateral offset (i.e., y-shift) of 1.0 mm;

FIG. 49B depicts a model of the cross-sectional intensity of a Gauss-Bessel beam with NA=0.16 vs. propagation distance along the optical axis, interacting with a textured glass surface having an amplitude of 5 μm*(Sin(2x)+Sin(2y))⁶ and a lateral offset (i.e., y-shift) of 1.0 mm;

FIG. 49C depicts a model of the cross-sectional intensity of a Gauss-Bessel beam with NA=0.18 vs. propagation distance along the optical axis, interacting with a textured glass surface having an amplitude of 5 μm*(Sin(2x)+Sin(2y))⁶ and a lateral offset (i.e., y-shift) of 1.0 mm;

FIG. 49D depicts a model of the cross-sectional intensity of a Gauss-Bessel beam with NA=0.21 vs. propagation distance along the optical axis, interacting with a textured glass surface having an amplitude of 5 μm*(Sin(2x)+Sin(2y))⁶ and a lateral offset (i.e., y-shift) of 1.0 mm;

FIG. 49E depicts a model of the cross-sectional intensity of a Gauss-Bessel beam with NA=0.26 vs. propagation distance along the optical axis, interacting with a textured glass surface having an amplitude of 5 μm*(Sin(2x)+Sin(2y))⁶ and a lateral offset (i.e., y-shift) of 1.0 mm;

FIG. 50A shows the modeled on-axis intensity of the Gauss Bessel beam of FIG. 49A vs. propagation distance along the optical axis;

FIG. 50B shows the modeled on-axis intensity of the Gauss Bessel beam of FIG. 49B vs. propagation distance along the optical axis;

FIG. 50C shows the modeled on-axis intensity of the Gauss Bessel beam of FIG. 49C vs. propagation distance along the optical axis;

FIG. 50D shows the modeled on-axis intensity of the Gauss Bessel beam of FIG. 49D vs. propagation distance along the optical axis;

FIG. 50E shows the modeled on-axis intensity of the Gauss Bessel beam of FIG. 49E vs. propagation distance along the optical axis;

FIG. 51 graphically depicts the length of the Gauss-Bessel beam shown in FIGS. 50A-50E, characterized by the full width at half-maximum of the on-axis beam intensity, as a function of numerical aperture.

FIG. 52A depicts a model of the cross-sectional intensity of a Gauss-Bessel beam with NA=0.15 vs. propagation distance along the optical axis, interacting with a textured glass surface having an amplitude of 10 μm*(Sin(2x)+Sin(2y))⁶ and a lateral offset (i.e., y-shift) of 0.0 mm;

FIG. 52B depicts a model of the cross-sectional intensity of a Gauss-Bessel beam with NA=0.16 vs. propagation distance along the optical axis, interacting with a textured glass surface having an amplitude of 10 μm*(Sin(2x)+Sin(2y))⁶ and a lateral offset (i.e., y-shift) of 0.0 mm;

FIG. 52C depicts a model of the cross-sectional intensity of a Gauss-Bessel beam with NA=0.18 vs. propagation distance along the optical axis, interacting with a textured glass surface having an amplitude of 10 μm*(Sin(2x)+Sin(2y))⁶ and a lateral offset (i.e., y-shift) of 0.0 mm;

FIG. 52D depicts a model of the cross-sectional intensity of a Gauss-Bessel beam with NA=0.21 vs. propagation distance along the optical axis, interacting with a textured glass surface having an amplitude of 10 μm*(Sin(2x)+Sin(2y))⁶ and a lateral offset (i.e., y-shift) of 0.0 mm;

FIG. 52E depicts a model of the cross-sectional intensity of a Gauss-Bessel beam with NA=0.26 vs. propagation distance along the optical axis interacting with a textured glass surface having an amplitude of 10 μm*(Sin(2x)+Sin(2y))⁶ and a lateral offset (i.e., y-shift) of 0.0 mm;

FIG. 53A shows the modeled on-axis intensity of the Gauss Bessel beam of FIG. 52A vs. propagation distance along the optical axis;

FIG. 53B shows the modeled on-axis intensity of the Gauss Bessel beam of FIG. 52B vs. propagation distance along the optical axis;

FIG. 53C shows the modeled on-axis intensity of the Gauss Bessel beam of FIG. 52C vs. propagation distance along the optical axis;

FIG. 53D shows the modeled on-axis intensity of the Gauss Bessel beam of FIG. 52D vs. propagation distance along the optical axis;

FIG. 53E shows the modeled on-axis intensity of the Gauss Bessel beam of FIG. 52E vs. propagation distance along the optical axis;

FIG. 54 graphically depicts the length of the Gauss-Bessel beam shown in FIGS. 53A-53E, characterized by the full width at half-maximum of the on-axis beam intensity, as a function of numerical aperture;

FIG. 55A depicts a model of the cross-sectional intensity of a Gauss-Bessel beam with NA=0.15 vs. propagation distance along the optical axis, interacting with a textured glass surface having an amplitude of 10 μm*(Sin(2x)+Sin(2y))⁶ and a lateral offset (i.e., y-shift) of 0.35 mm;

FIG. 55B depicts a model of the cross-sectional intensity of a Gauss-Bessel beam with NA=0.16 vs. propagation distance along the optical axis, interacting with a textured glass surface having an amplitude of 10 μm*(Sin(2x)+Sin(2y))⁶ and a lateral offset (i.e., y-shift) of 0.35 mm;

FIG. 55C depicts a model of the cross-sectional intensity of a Gauss-Bessel beam with NA=0.18 vs. propagation distance along the optical axis, interacting with a textured glass surface having an amplitude of 10 μm*(Sin(2x)+Sin(2y))⁶ and a lateral offset (i.e., y-shift) of 0.35 mm;

FIG. 55D depicts a model of the cross-sectional intensity of a Gauss-Bessel beam with NA=0.21 vs. propagation distance along the optical axis, interacting with a textured glass surface having an amplitude of 10 μm*(Sin(2x)+Sin(2y))⁶ and a lateral offset (i.e., y-shift) of 0.35 mm;

FIG. 55E depicts a model of the cross-sectional intensity of a Gauss-Bessel beam with NA=0.26 vs. propagation distance along the optical axis, interacting with a textured glass surface having an amplitude of 10 μm*(Sin(2x)+Sin(2y))⁶ and a lateral offset (i.e., y-shift) of 0.35 mm;

FIG. 56A shows the modeled on-axis intensity of the Gauss Bessel beam of FIG. 55A vs. propagation distance along the optical axis;

FIG. 56B shows the modeled on-axis intensity of the Gauss Bessel beam of FIG. 55B vs. propagation distance along the optical axis;

FIG. 56C shows the modeled on-axis intensity of the Gauss Bessel beam of FIG. 55C vs. propagation distance along the optical axis;

FIG. 56D shows the modeled on-axis intensity of the Gauss Bessel beam of FIG. 55D vs. propagation distance along the optical axis;

FIG. 56E shows the modeled on-axis intensity of the Gauss Bessel beam of FIG. 55E vs. propagation distance along the optical axis;

FIG. 57 graphically depicts the length of the Gauss-Bessel beam shown in FIGS. 56A-56E, characterized by the full width at half-maximum of the on-axis beam intensity, as a function of numerical aperture;

FIG. 58A depicts a model of the cross-sectional intensity of a Gauss-Bessel beam with NA=0.15 vs. propagation distance along the optical axis, interacting with a textured glass surface having an amplitude of 10 μm*(Sin(2x)+Sin(2y))⁶ and a lateral offset (i.e., y-shift) of 1.0 mm;

FIG. 58B depicts a model of the cross-sectional intensity of a Gauss-Bessel beam with NA=0.16 vs. propagation distance along the optical axis, interacting with a textured glass surface having an amplitude of 10 μm*(Sin(2x)+Sin(2y))⁶ and a lateral offset (i.e., y-shift) of 1.0 mm;

FIG. 58C depicts a model of the cross-sectional intensity of a Gauss-Bessel beam with NA=0.18 vs. propagation distance along the optical axis, interacting with a textured glass surface having an amplitude of 10 μm*(Sin(2x)+Sin(2y))⁶ and a lateral offset (i.e., y-shift) of 1.0 mm;

FIG. 58D depicts a model of the cross-sectional intensity of a Gauss-Bessel beam with NA=0.21 vs. propagation distance along the optical axis, interacting with a textured glass surface having an amplitude of 10 μm*(Sin(2x)+Sin(2y))⁶ and a lateral offset (i.e., y-shift) of 1.0 mm;

FIG. 58E depicts a model of the cross-sectional intensity of a Gauss-Bessel beam with NA=0.26 vs. propagation distance along the optical axis, interacting with a textured glass surface having an amplitude of 10 μm*(Sin(2x)+Sin(2y)) and a lateral offset (i.e., y-shift) of 1.0 mm;

FIG. 59A shows the modeled on-axis intensity of the Gauss Bessel beam of FIG. 58A vs. propagation distance along the optical axis;

FIG. 59B shows the modeled on-axis intensity of the Gauss Bessel beam of FIG. 58B vs. propagation distance along the optical axis;

FIG. 59C shows the modeled on-axis intensity of the Gauss Bessel beam of FIG. 58C vs. propagation distance along the optical axis;

FIG. 59D shows the modeled on-axis intensity of the Gauss Bessel beam of FIG. 58D vs. propagation distance along the optical axis;

FIG. 59E shows the modeled on-axis intensity of the Gauss Bessel beam of FIG. 58E vs. propagation distance along the optical axis;

FIG. 60 graphically depicts the length of the Gauss-Bessel beam shown in FIGS. 59A-59E, characterized by the full width at half-maximum of the on-axis beam intensity, as a function of numerical aperture;

FIG. 61 depicts cross sections of separated edges of glass sheets after nano-perforation;

FIG. 62 depicts a cross section of separated edge of a glass sheet after nano-perforation;

FIG. 63 depicts a cross section of a separated edge of a glass sheet after nano-perforation;

FIG. 64 depicts a cross section of a separated edge of a glass sheet after nano-perforation;

FIG. 65 depicts a cross section of a separated edge of a glass sheet after nano-perforation;

FIG. 66 depicts the cross section of FIG. 66 further magnified;

FIG. 67 depicts nano-perforation depth as a function of angle of incidence on a tilted glass surface;

FIG. 68 graphically depicts a comparison of Bessel beams with two different numerical apertures for tolerance of nano-perforation penetration depth to glass tilt;

FIG. 69 depicts ray tracing model comparing the intensity cross profile vs. propagation distance of Bessel beams with different numerical apertures for tolerance to curved glass surface;

FIG. 70 depicts focal line measurements of a NA=0.201 Gauss-Bessel beam used for nano-perforation of a glass tube;

FIG. 71 depicts focal line measurements of a NA=0.312 Gauss-Bessel beam used for nano-perforation of a glass tube; and

FIG. 72 depicts a comparison of nano-perforation penetration depth into 5 mm radius of curvature surface of a glass tube using Gauss-Bessel beams with NA=0.201 and NA=0.312.

### DETAILED DESCRIPTION

Reference will now be made in detail to embodiments of separating a transparent workpiece including a textured surface. It is desired to separate the transparent workpiece along a line of separation that does not significantly deviate from a desired line of separation to reduce the need to perform post-processing steps (e.g., grinding, polishing, and the like) on the separated transparent workpiece for the separated transparent workpiece to possess a desired shape. The textured surface of the transparent workpiece may scatter and distort a laser beam used in laser processing the transparent workpiece, leading to lines of separation that deviate from the desired line of separation and/or sub-surface damage along the lines of separation, necessitating post-processing steps that remove significant portions of the transparent workpiece to produce a workpiece that conforms to a desired shape, thereby diminishing material utilization and increasing manufacturing costs. The methods described herein utilize a laser beam having a low numerical aperture (e.g., less than or equal to 0.25) to fully perforate the transparent workpiece and guide propagation of a crack along a desired line of separation to reduce the extent of post-processing needed to produce a workpiece having a desired shape.

As used herein, the term “textured surface” refers to a surface of a transparent workpiece having a Ra value of greater than or equal to 0.5 μm. It should be understood that the methods described herein may be used for textured surface having a wide range of Ra values. For example, in embodiments, the textured surfaces described herein may have Ra values that are greater than or equal to 0.5 μm and less than or equal to 5 μm, or greater than or equal to 0.5 μm and less than or equal to 10 μm, or greater than or equal to 1.0 μm, or greater than or equal to 2.0 μm, or greater than or equal to 3.0 μm, or greater than or equal to 4.0 μm, or less than or equal to 10 μm, or less than or equal to 8.0 μm, or less than or equal to 6.0 μm. Such textured surfaces may result from formation of the transparent workpiece. For example, embodiments may involve laser processing of transparent workpieces that are rolled glass or glass-ceramic sheets, formed by the application of rollers to a glass or glass-ceramic precursor. The contact of the rollers to the precursor may impart a textured surface onto the transparent workpiece. Embodiments may also involve laser processing of glass-ceramic transparent workpieces, where the ceramming process imparts surface texture to the transparent workpiece. Furthermore, a rolling or ceramming process may include the use of boron nitride as a lubricant, which can leave residual boron nitride embedded in the glass surface after rolling or ceramming is complete and give rise to a textured surface.

As used herein, the term “Ra value” refers to a surface roughness measure of the arithmetic average value of a filtered roughness profile determined from deviations from a centerline of the filtered roughness. For purposes of the present disclosure, Ra is determined from the relation:

Ra=1/nΣᵢ₌₁ⁿ|Hᵢ−H_{CL}| (1)

where the summation is over n points of measurement on the surface, the summation index i indexes the individual measurement points, Hᵢ is a surface height measurement of the surface at measurement point i, and H_{CL} corresponds to a centerline (e.g., the center between maximum and minimum surface height values) surface height measurement among the data points of the filtered profile. Alternatively, a Sa value may be used to characterize the surface roughness, which is determined through an areal extrapolation of equation (1) herein. Filter values (e.g., cutoff wavelengths) for determining the Ra values described herein may be found in ISO 25718. Surface height may be measured with a variety of tools, such as an optical interferometer, stylus-based profilometer, or laser confocal microscope. Unless otherwise specified herein, Ra values were measured via a laser confocal microscope. To assess the roughness of the textured surfaces, measurement regions should be used that are as large as is practical, in order to assess variability that may occur over large spatial scales. For example, a transparent workpiece constructed of rolled glass may have inclusions caused by boron nitride particulate that can be of a lateral scale˜100 μm. As such, for the textured surfaces described here, measurement regions of 3×3 mm were typically used to assess Ra. In particular, a Keyence VK-X200 laser confocal was used to make measurements with a 5× objective lends which gave a measured field-of-view of about 2.2 mm×2.9 mm, corresponding to a resolution of 2.84 μm per pixel. The mode used was “surface profile” mode, at a quality setting of “high accuracy.” The sampling used for the calculations and analysis was 8 μm pitch. AI noise elimination was “ON.” Angled surface noise filer was “Auto (ON).” However, for assessing the cut edge surfaces, the thickness of the transparent workpiece limits the practical size of the measurement region, so that regions of at least 100 μm×100 μm in size were more appropriate.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the specific value or end-point referred to is included. Whether or not a numerical value or end-point of a range in the specification recites “about,” two embodiments are described: one modified by “about,” and one not modified by “about.” It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply ab solute orientation.

As used herein, the singular forms “a,” “an” and “the” include plural referents unless the context clearly dictates otherwise. Thus, for example, reference to “a” component includes aspects having two or more such components, unless the context clearly indicates otherwise.

As used herein, “as-cut condition” refers to a state of a portion of a transparent workpiece immediately after the transparent workpiece has been separated along a plurality of defects formed in the transparent workpiece, without any post-processing steps (e.g., grinding, polishing, etching, roughening, and the like) being applied to the portion of the transparent workpiece. Such separation may occur in response to a stress (e.g., a thermal stress, a mechanical stress, or the like) or other separation means (e.g., a chemical etchant) being applied to the transparent workpiece at the plurality of defects. The separated portion of the transparent workpiece may include a cut edge at which the separation took place. Portions (or entireties) of the plurality of defects may remain in the separated portion at or proximate to the cut edge when the separated portion is in an as-cut condition.

As used herein, “laser processing” comprises directing a laser beam onto and/or into a transparent workpiece. In some embodiments, laser processing further comprises translating the laser beam relative to the transparent workpiece, for example, along a contour line or other pathway. Examples of laser processing include using a laser beam to form a contour comprising a series of defects that extend into the transparent workpiece and using an infrared laser beam to heat the transparent workpiece. Other examples of laser processing including using a laser beam to form a contour comprising a series of defects that extend into the transparent workpiece and using alternative means to separate the transparent workpiece along the series of defects (e.g., mechanical stress, application of a chemical etchant, or the like). Laser processing may separate the transparent workpiece along one or more lines of separation.

As used herein, “beam spot” refers to a cross section of a laser beam (e.g., a beam cross section) at the impingement location of the laser beam at an impingement surface of a transparent workpiece. The impingement surface is the surface of the transparent workpiece upon which the laser beam is first incident. The beam spot is the cross-section at the impingement location. In the embodiments described herein, the beam spot is sometimes referred to as being “axisymmetric” or “non-axisymmetric.” As used herein, axisymmetric refers to a shape (e.g., circular) that is symmetric, or appears the same, for any arbitrary rotation angle made about a central axis, and “non-axisymmetric” refers to a shape that is not symmetric for any arbitrary rotation angle made about a central axis (e.g. oval, elliptical). The rotation axis (e.g., the central axis) is most often taken as being the optical axis (axis of propagation) of the laser beam, which is the axis extending in the beam propagation direction, which is referred to herein as the Z-direction.

As used herein, “upstream” and “downstream” refer to the relative position of two locations or components along a beam pathway with respect to a beam source. For example, a first component is upstream from a second component if the first component is closer to the beam source along the path traversed by the laser beam than the second component. A first component is downstream from a second component if the first component is farther from the beam source than the second component along the path traversed by the laser beam (i.e., if the laser beam is incident on the second component prior to being incident on the first component).

As used herein, “laser beam focal line” or “pulsed laser beam focal line” refer to a pattern of interacting (e.g., crossing) light rays of a pulsed laser beam that forms a focal region elongated in the beam propagation direction. In conventional laser processing, a pulsed laser beam is tightly focused to a focal point. The focal point is the point of minimum cross section of the pulsed laser beam, often referred to as the beam “waist”, and is situated at a focal plane in a substrate, such as the transparent workpiece. In the elongated focal region of a pulsed laser beam focal line, in contrast, the region of minimum cross section of the pulsed laser beam is no longer a single point, but instead forms a linear or approximately linear extended region aligned with the beam propagation direction. As discussed below, a focal line has a length in the direction of beam propagation and a cross-section having finite dimensions in a direction normal to the direction of beam propagation. A pulsed laser beam focal line is formed by converging light rays of a pulsed laser beam that intersect (e.g., cross) to form a continuous series of focal points aligned with the beam propagation direction. The pulsed laser beam focal lines described herein are formed using a quasi-non-diffracting beam, mathematically defined in detail below.

As used herein, “contour line” corresponds to the set of intersection points of the laser beam with a transparent workpiece resulting from relative motion of the laser beam and the transparent workpiece. A contour line can be a linear, angled, polygonal or curved in shape. A contour line can be closed (i.e. defining an enclosed region on the surface of the transparent workpiece) or open (i.e. not defining an enclosed region on the surface of the transparent workpiece). The contour line represents a boundary along which separation of the transparent workpiece into two or more parts is facilitated. In embodiments, the contour line represents a boundary between a discarded portion of the transparent workpiece and a primary or utilized region of the transparent workpiece.

As used herein, “contour,” refers to a set of defects in a transparent workpiece formed by a laser beam through relative motion of a laser beam and the transparent workpiece along a contour line. The defects are spaced apart along the contour line and are wholly contained within the interior of the transparent workpiece or extend through one or more surfaces into the interior of the transparent workpiece. Defects may also extend through the entire thickness of the transparent workpiece. Separation of the transparent workpiece occurs by connecting defects, such as, for example, through propagation of a crack, preferably along the boundary defined by the contour line.

As used herein, a “defect” refers to a region of a transparent workpiece that has been modified by a laser beam. Modification means that the substrate has been weakened mechanically (and thus “damaged”) by the laser beam. Typical modifications include compaction and cleaving of chemical bonds. Defects include regions of a transparent workpiece having a modified refractive index relative to surrounding unmodified regions of the transparent workpiece. Common defects include structurally modified regions such as void spaces, cracks, scratches, flaws, holes, perforations, densifications, or other deformities in the transparent workpiece produced by a pulsed laser beam focal line. Defects may also be referred to, in various embodiments herein, as defect lines or damage tracks. The defects described herein include material modifications (e.g., refractive index modifications, cracks, void spaces, flaws) that are completely encapsulated within a thickness of the transparent workpiece. The defects described herein may extend through the entire thickness of a transparent workpiece or a portion thereof, such as greater than 50%, or greater than 60%, or greater than 70%, or greater than 80%, or greater than 90%, or in a range from 50% to 100%, or in a range from 60% to 95%, or in a range from 70% to 90% of the thickness of a transparent workpiece.

As used herein, the term “defect-forming laser beam” refers to a laser beam that forms a defect in a transparent workpiece.

In embodiments, the plurality of nano-perforations include a modified material diameter. As used herein, the term “modified material diameter” include aspects of each of the nano-perforations not including cracks that extend into the transparent workpiece as a result of formation of the plurality of nano-perforations. For example, the modified material diameter may measure a size of a portion of the transparent workpiece within one of the nano-perforations including refractive index modifications, changes in molecular bonding, and voids in the transparent workpiece that are completely encapsulated within the thickness. In embodiments, an aspect ratio of one of the plurality of nano-perforations may be described as a ratio of the nano-perforation length and the modified material diameter. In embodiments, the aspect ratio of each of the plurality of nano-perforations is greater than or equal to 50:1 (e.g., greater than or equal to 100:1).

In embodiments, a defect or damage track is formed through interaction of a pulsed laser beam focal line with the transparent workpiece. As described more fully below, the pulsed laser beam focal line is produced by a pulsed laser. A defect at a particular location along the contour line is formed from a pulsed laser beam focal line produced by a single laser pulse at the particular location, a pulse burst of sub-pulses at the particular location, or multiple laser pulses at the particular location. Relative motion of the laser beam and transparent workpiece along the contour line results in multiple defects that form a contour.

The phrase “transparent workpiece,” as used herein, means a workpiece formed from glass, glass-ceramic or other material that is transparent, where the term “transparent,” as used herein, means that the material has a linear optical absorption of less than 20% per mm of material depth, such as less than 10% per mm of material depth for the specified pulsed laser wavelength, or such as less than 1% per mm of material depth for the specified pulsed laser wavelength. Unless otherwise specified, a material is transparent if it has a linear optical absorption of less than 20% per mm of material depth. In embodiments, the linear optical absorption of the transparent workpieces described herein is measured by transmitting a non-focused (e.g., collimated) laser beam (e.g., not having a sufficiently high intensity to induce non-linear absorption) through a transparent workpiece. The power of the non-focused laser beam transmitted through the transparent workpiece is then compared to an initial power of the non-focused laser beam to determine a percentage of the light absorbed by the transparent workpiece. The measured absorption values may be normalized for transparent workpiece thickness. In embodiments, the transparent workpieces described herein may have a depth (e.g., thickness) of greater than or equal to 50 microns (μm), or greater than or equal to 100 microns (μm), or greater than or equal to 250 microns (μm), or greater than or equal to 500 microns (μm), or greater than or equal to 1.0 millimeter (mm), or greater than or equal to 2.0 mm, or greater than or equal to 3.0 mm, or greater than or equal to 4.0 mm, or greater than or equal to 5.0 mm, or greater than or equal to 6.0 mm, or greater than or equal to 8.0 mm, or greater than or equal to 50 μm and less than or equal to 10.0 mm, or greater than or equal to 100 μm and less than or equal to 5.0 mm, or greater than or equal to 0.5 mm and less than or equal to 3.0 mm. Transparent workpieces may comprise glass workpieces formed from glass compositions, such as borosilicate glass, soda-lime glass, aluminosilicate glass, alkali aluminosilicate, alkaline earth aluminosilicate glass, alkaline earth boro-aluminosilicate glass, fused silica, or crystalline materials such as sapphire, silicon, gallium arsenide, or combinations thereof. In some embodiments, the glass may be ion-exchangeable, such that the glass composition can undergo ion-exchange for glass strengthening before or after laser processing the transparent workpiece.

As used herein, “glass-ceramics” are solids prepared by controlled crystallization of a precursor glass and have one or more crystalline phases and a residual glass phase.

As used herein, the term “quasi-non-diffracting beam” is used to describe a laser beam having low beam divergence as mathematically described below. In particular, the laser beam used to form a contour of defects in the embodiments described herein. The laser beam has an intensity distribution I(X,Y,Z), where Z is the beam propagation direction of the laser beam, and X and Y are directions orthogonal to the beam propagation direction, as depicted in the figures. The X-direction and Y-direction may also be referred to as cross-sectional directions and the X-Y plane may be referred to as a cross-sectional plane. The coordinates and directions X, Y, and Z are also referred to herein as x, y, and z; respectively. The intensity distribution of the laser beam in a cross-sectional plane may be referred to as a cross-sectional intensity distribution. The quasi-non-diffracting laser beam may be formed by impinging a diffracting laser beam (such as a Gaussian beam) into, onto, and/or thorough a phase-altering optical element, such as an adaptive phase-altering optical element (e.g., a spatial light modulator, an adaptive phase plate, a deformable mirror, or the like), a static phase-altering optical element (e.g., a static phase plate, an aspheric optical element, such as an axicon, or the like), to modify the phase of the beam, to reduce beam divergence, and to increase Rayleigh range, as mathematically defined below. Example quasi-non-diffracting beams include Bessel beams, Airy beams, and Weber beams. As used herein, the term “Bessel beam” refers to Bessel beams, Gauss-Bessel beams, and Bessel-like beams.

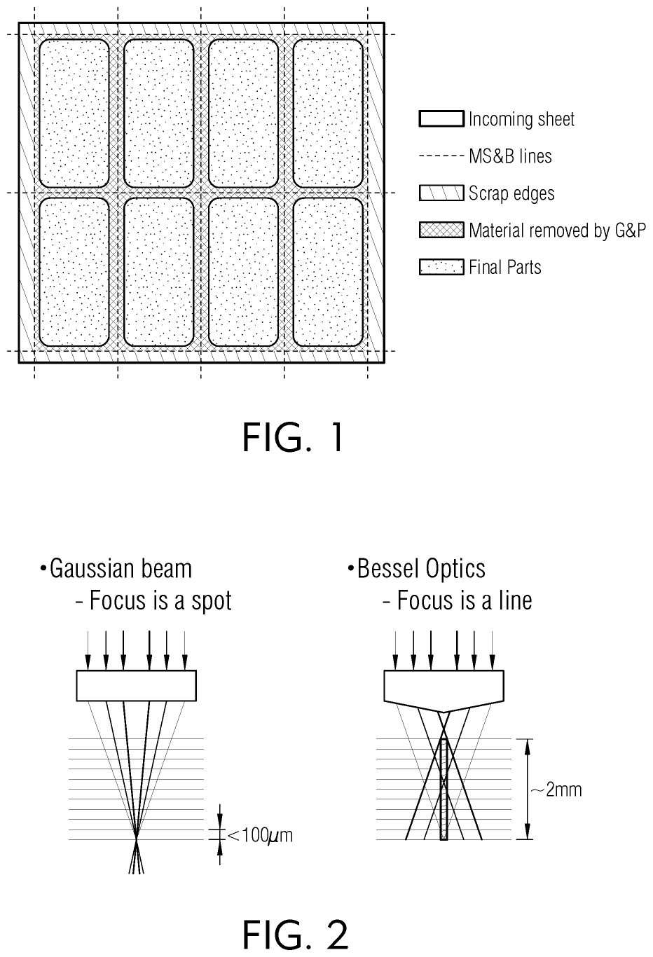

Referring now to FIG. 1, conventional mechanical score and break laser cutting has limitations in precision (about 100 microns) and may cause significant chipping and sub-surface damage to the scored edge of the glass (about 150 microns). “Sub-surface damage” is defined as the distance edge flaws (cracks or other defects) extend inward perpendicularly into the cut edge of the glass sheet. To achieve high edge strength and reliability of the final part, these edge flaws must be removed through mechanical grind and polish. With mechanical score and break leaser cutting, it may also be difficult to make parts that have rounded edge contours, such as the rounded corners (also referred to herein as “radiused corners”) present on many hand-held electronic devices. Mechanical score and break laser cutting may also require a minimum separation between the parts to be cut (e.g., 5-10 mm). This required minimum separation necessitates grinding and polishing of the edges to round corners to a specified radius of curvature and to remove the sub-surface damage and account for the lack of precision in the cut edge itself. Depending on the exact part shape and incoming glass sheet size, this may lead to sheet utilization percentages ranging from 90% to as low as 50%. Some of the lost material remains macroscopic in size, and may be recycled and remelted as cullet in future glass melts. But, ground material cannot be recycled as cullet, meaning there are disposal and environmental costs imparted that scale with the volume of material to be ground and polished away. For mechanical score and break laser cut parts, this ground material loss may be from 10% to 30% of the total material.

Referring now to FIG. 2, quasi-non-diffracting laser beams, such as Bessel beams, may be used for laser processing of glass sheets. Non-diffracting means that these laser beams retain a tight focused spot (e.g., a core diameter of about 1-10 μm) through a much longer depth of focus in the direction of beam propagation than is possible with traditional Gaussian profile laser beams. The cross sectional profile of the quasi-non-diffracting laser beam most often resembles a Bessel-function profile, with a central peak of high intensity and multiple annular shaped sidelobes of lesser intensity.

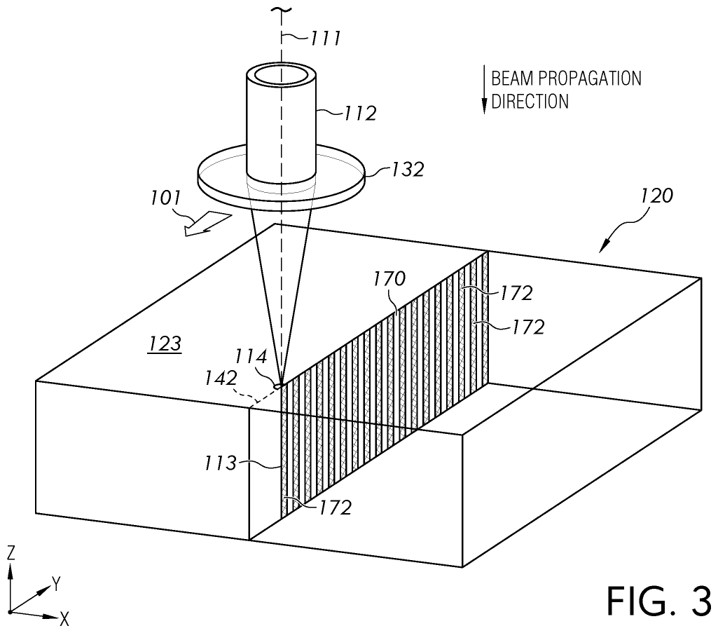

Referring to FIGS. 3, 4, and 5, the pulsed laser beam 112 used to form the defects further has an intensity distribution I(X,Y,Z), where Z is the beam propagation direction of the pulsed laser beam 112, and X and Y are directions orthogonal to the direction of propagation, as depicted in the figures. The X-direction and Y-direction may also be referred to as cross-sectional directions and the X-Y plane may be referred to as a cross-sectional plane. The intensity distribution of the pulsed laser beam 112 in a cross-sectional plane may be referred to as a cross-sectional intensity distribution.

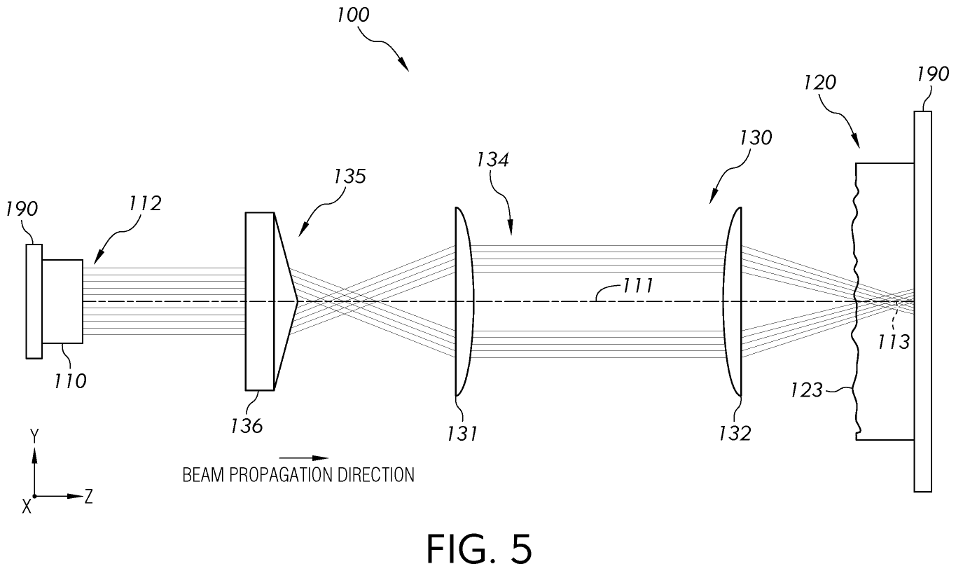

The pulsed laser beam 112 at the beam spot 114 or other cross sections may comprise a quasi-non-diffracting beam, for example, a beam having low beam divergence as mathematically defined herein, by propagating the pulsed laser beam 112 (e.g., outputting the pulsed laser beam 112, such as a Gaussian beam, using a pulsed beam source 110) through an aspheric optical element 135, as described in more detail herein with respect to the optical assembly 100 depicted in FIG. 5. Beam divergence refers to the rate of enlargement of the beam cross section in the direction of beam propagation (i.e., the Z-direction). As used herein, the phrase “beam cross section” refers to the cross section of the pulsed laser beam 112 along a plane perpendicular to the beam propagation direction of the pulsed laser beam 112, for example, along the X-Y plane. One example beam cross section discussed herein is the beam spot 114 of the pulsed laser beam 112 projected onto a textured surface 123 of a transparent workpiece 120.

The length of the pulsed laser beam focal line produced from a quasi-non-diffracting beam is determined by the Rayleigh range of the quasi-non-diffracting beam. Particularly, the quasi-non-diffracting beam defines a pulsed laser beam focal line 113 having a first end point and a second end point each defined by locations where the quasi-non-diffracting beam has propagated a distance from the beam waist equal to a Rayleigh range of the quasi-non-diffracting beam. The length of the laser beam focal line corresponds to twice the Rayleigh range of the quasi-non-diffracting beam. A detailed description of the formation of quasi-non-diffracting beams and determining their length, including a generalization of the description of such beams to asymmetric (such as non-axisymmetric) beam cross sectional profiles, is provided in U.S. Pat. No. 10,730,783, which is incorporated by reference in its entirety.

The Rayleigh range corresponds to the distance (relative to the position of the beam waist as defined in Section 3.12 of ISO 11146-1:2005(E)) over which the variance of the laser beam doubles (relative to the variance at the position of the beam waist) and is a measure of the divergence of the cross sectional area of the laser beam. The Rayleigh range can also be observed as the distance along the beam axis at which the peak optical intensity observed in a cross sectional profile of the beam decays to one half of its value observed in a cross sectional profile of the beam at the beam waist location (location of maximum intensity). Laser beams with large Rayleigh ranges have low divergence and expand more slowly with distance in the beam propagation direction than laser beams with small Rayleigh ranges.

Beam cross section is characterized by shape and dimensions. The dimensions of the beam cross section are characterized by a spot size of the beam. For a Gaussian beam, spot size is frequently defined as the radial extent at which the intensity of the beam decreases to 1/e² of its maximum value. The maximum intensity of a Gaussian beam occurs at the center (x=0 and y=0 (Cartesian) or r=0 (cylindrical)) of the intensity distribution and radial extent used to determine spot size is measured relative to the center.

Beams with Gaussian intensity profiles may be less preferred for laser processing to form a contour of defects because, when focused to small enough spot sizes (such as spot sizes in the range of microns, such as about 1-5 μm or about 1-10 μm) to enable available laser pulse energies to modify materials such as glass, they are highly diffracting and diverge significantly over short propagation distances (low Rayleigh range). To achieve low divergence (high Rayleigh range), it is desirable to control or optimize the intensity distribution of the pulsed laser beam to reduce diffraction. Pulsed laser beams may be non-diffracting or weakly diffracting. Weakly diffracting laser beams include quasi-non-diffracting laser beams. Representative weakly diffracting laser beams include Bessel beams, Airy beams, Weber beams, and Mathieu beams.

Non-diffracting or quasi-non-diffracting beams generally have complicated intensity profiles, such as those that decrease non-monotonically vs. radius. By analogy to a Gaussian beam, an effective spot size w_{o,eff} can be defined for any beam, even non-axisymmetric beams, as the shortest radial distance, in any direction, from the radial position of the maximum intensity (r=0) at which the intensity decreases to 1/e² of the maximum intensity. Further, for axisymmetric beams w_{o,eff} is the radial distance from the radial position of the maximum intensity (r=0) at which the intensity decreases to 1/e² of the maximum intensity. A criterion for Rayleigh range Z_{R} based on the effective spot size w_{o,eff} for axisymmetric beams can be specified as non-diffracting or quasi-non-diffracting beams for forming damage regions in Equation (3), below:

$${Z}_{R} > {F}_{D} \frac{π {w}_{0 , eff}^{2}}{λ} \qquad ( 3 )$$

where F_{D} is a dimensionless divergence factor having a value of at least 10, in an embodiment at least 50, in an embodiment at least 100, in an embodiment at least 250, in particular at least 500 and in another embodiment at least 1000. In a further embodiment F_{D} can be in the range from 10 to 2000, in particular in the range from 50 to 1500 and furthermore in particular in the range from 100 to 1000. For a non-diffracting or quasi-non-diffracting beam the distance (Rayleigh range), Z_{R} in Equation (1), over which the effective spot size doubles, is F_{D} times the distance expected if a typical Gaussian beam profile were used. The dimensionless divergence factor F_{D} provides a criterion for determining whether or not a laser beam is quasi-non-diffracting. As used herein, the pulsed laser beam 112 is considered quasi-non-diffracting if the characteristics of the laser beam satisfy Equation (1) with a value of F_{D}≥10. As the value of F_{D} increases, the pulsed laser beam 112 approaches a more nearly perfectly non-diffracting state. Thus, as the value of F_{D} increases, the length of the laser beam focal line increases, facilitating the formation of longer defects.

Additional information about Rayleigh range, beam divergence, intensity distribution, axisymmetric and non-axisymmetric beams, and spot size as used herein can also be found in the international standards ISO 11146-1:2005(E) entitled “Lasers and laser-related equipment—Test methods for laser beam widths, divergence angles and beam propagation ratios—Part 1: Stigmatic and simple astigmatic beams”, ISO 11146-2:2005(E) entitled “Lasers and laser-related equipment—Test methods for laser beam widths, divergence angles and beam propagation ratios—Part 2: General astigmatic beams”, and ISO 11146-3:2004(E) entitled “Lasers and laser-related equipment—Test methods for laser beam widths, divergence angles and beam propagation ratios—Part 3: Intrinsic and geometrical laser beam classification, propagation and details of test methods”, the disclosures of which are incorporated herein by reference in their entirety.

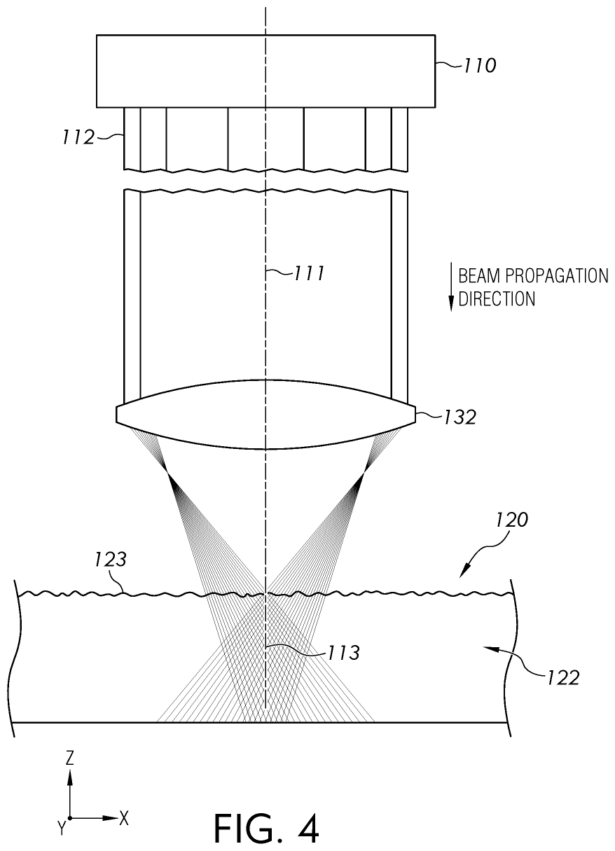

Referring now to FIGS. 3 and 4, a transparent workpiece 120 comprising a textured surface 123 is schematically depicted undergoing laser processing according to the methods described herein. In particular, FIGS. 3 and 4 schematically depict directing a pulsed laser beam 112 that is output by a pulsed beam source 110, such as a Gaussian pulsed beam source, and oriented along a beam pathway 111 into the transparent workpiece 120 to form a defect 172 in the transparent workpiece 120, for example, extending into the transparent workpiece 120. The pulsed laser beam 112 propagates along the beam pathway 111 and is oriented such that the pulsed laser beam 112 may be focused into a pulsed laser beam focal line 113 within the transparent workpiece 120, for example, using an aspheric optical element 135 and one or more lenses (FIG. 5). The pulsed laser beam focal line 113 generates an induced absorption within the transparent workpiece 120 to produce the defect 172 within the transparent workpiece 120 that may extend into the transparent workpiece 120. Furthermore, a contour 170 of defects 172 may be formed in the transparent workpiece 120 by translating at least one of the pulsed laser beam 112 and the transparent workpiece 120 relative to one another such that the pulsed laser beam 112 translates relative to the transparent workpiece 120 in a translation direction 101. The pulsed laser beam 112 forms a beam spot 114 projected onto textured surface 123 of the transparent workpiece 120.

Referring also to FIG. 5, the pulsed laser beam 112 may be focused into the pulsed laser beam focal line 113 using a lens 132, which is the final focusing element in an optical assembly 100. While a single lens 132 is depicted in FIGS. 3 and 4, the optical assembly 100 further comprises an aspheric optical element 135, which modifies the pulsed laser beam 112 such that the pulsed laser beam 112 has a quasi-non-diffracting character downstream the aspheric optical element 135. Thus, when the portion of the pulsed laser beam 112 shown in FIGS. 3 and 4 impinges the lens 132, the pulsed laser beam 112 has a quasi-non-diffracting character. Furthermore, some embodiments may include a lens assembly 130 including, for example a first lens 131 and a second lens 132, and repetitions thereof (FIG. 5) to focus the pulsed laser beam 112 into the pulsed laser beam focal line 113. Other standard optical elements (e.g. prisms, beam splitters etc.) may also be included in lens assembly 130.

As depicted in FIG. 3, the pulsed laser beam 112 may comprise an annular shape when impinging the lens 132. While the lens 132 is depicted focusing the pulsed laser beam 112 into the pulsed laser beam focal line 113 in FIG. 3, other embodiments may use the aspheric optical element 135 (FIG. 2), which modifies the pulsed laser beam 112 such that the pulsed laser beam 112 has a quasi-non-diffracting character downstream of the aspheric optical element 135, to also focus the pulsed laser beam 112 into the pulsed laser beam focal line 113. In other words, in some embodiments, the lens 132 may be the final focusing element and in other embodiments, the aspheric optical element 135 may be the final focusing element. The pulsed laser beam focal line 113 may have a length in a range of from about 0.1 mm to about 100 mm or in a range of from about 0.1 mm to about 10 mm. Various embodiments may be configured to have a pulsed laser beam focal line 113 with a length 1 of about 0.1 mm, about 0.2 mm, about 0.3 mm, about 0.4 mm, about 0.5 mm, about 0.7 mm, about 1.0 mm, about 2.0 mm, about 3.0 mm, about 4.0 mm, or about 5.0 mm, or about 10.0 mm, or ranges therebetween; e.g., from about 0.5 mm to about 5.0 mm, or about 1.0 mm to about 10.0 mm, etc. In other embodiments, the length of the laser beam focal line is greater than or equal to the thickness of the transparent workpiece, or greater than or equal to 50% of the thickness of the transparent workpiece, or greater than or equal to 75% of the thickness of the transparent workpiece. The length of the pulsed laser beam focal line 113 may be selected based on the particular laser processing goals. As one example, for thicker transparent workpieces 120, it may be advantageous to form longer pulsed laser beam focal lines 113. As another example, if defects 172 extending into only discrete depth sections of the transparent workpiece 120 are desired, it may be advantageous to form shorter pulsed laser beam focal lines 113.

Referring now to FIG. 5, the optical assembly 100 for producing a pulsed laser beam 112 that is quasi-non-diffracting and forms the pulsed laser beam focal line 113 at the transparent workpiece 120 using the aspheric optical element 135 (e.g., an axicon 136) is schematically depicted. The optical assembly 100 includes a pulsed beam source 110 that outputs the pulsed laser beam 112, and the lens assembly 130 comprising the first lens 131 and the second lens 132. The transparent workpiece 120 may be positioned such that the pulsed laser beam 112 output by the pulsed beam source 110 irradiates transparent workpiece 120, for example, after traversing the aspheric optical element 135 and thereafter, both the first lens 131 and the second lens 132.

The aspheric optical element 135 is positioned within the beam pathway 111 between the pulsed beam source 110 and the transparent workpiece 120. In operation, propagating the pulsed laser beam 112, e.g., an incoming Gaussian beam, through the aspheric optical element 135 may alter, for example, phase alter, the pulsed laser beam 112 such that the portion of the pulsed laser beam 112 propagating beyond the aspheric optical element 135 is quasi-non-diffracting, as described above. The aspheric optical element 135 may comprise any optical element comprising an aspherical shape. In some embodiments, the aspheric optical element 135 may comprise a conical wavefront producing optical element, such as an axicon lens, for example, a negative refractive axicon lens (e.g., negative axicon), a positive refractive axicon lens, a reflective axicon lens, a diffractive axicon lens, a phase axicon, a diffractive optic, a cubically shaped optical element, or the like.

While the optical assembly 100 is primarily described as altering the pulsed laser beam 112 into a quasi-non-diffracting beam using the aspheric optical element 135, it should be understood that a quasi-non-diffracting beam may also be formed by other phase-altering optical elements, such as a spatial light modulator, an adaptive phase plate, a static phase plate, a deformable mirror, diffractive optical grating, or the like. Each of these phase-altering optical elements, including the aspheric optical element 135, modify the phase of the pulsed laser beam 112, to reduce beam divergence, increase Rayleigh range, and form a quasi-non-diffracting beam as mathematically defined herein.

Referring still to FIG. 5, the lens assembly 130 comprises two lenses, with the first lens 131 positioned upstream from the second lens 132. The first lens 131 may collimate the pulsed laser beam 112 within a collimation space 134 between the first lens 131 and the second lens 132. Further, the most downstream positioned second lens 132 of the lens assembly 130 may focus the pulsed laser beam 112 into the transparent workpiece 120. In some embodiments, the first lens 131 and the second lens 132 each comprise plano-convex lenses. When the first lens 131 and the second lens 132 each comprise plano-convex lenses, the curvature of the first lens 131 and the second lens 132 may each be oriented toward the collimation space 134. In other embodiments, the first lens 131 may comprise a collimating lens and the second lens 132 may comprise a meniscus lens, an aspheric lens, or another higher-order corrected focusing lens. In operation, the lens assembly 130 may control the position of the pulsed laser beam focal line 113 along the beam pathway 111. In further embodiments, the lens assembly 130 may comprise an 8F lens assembly, a 4F lens assembly comprising a single set of first and second lenses 131, 132, or any other known or yet to be developed lens assembly 130 for focusing the pulsed laser beam 112 into the pulsed laser beam focal line 113. Moreover, it should be understood that some embodiments may not include the lens assembly 130 and instead, the aspheric optical element 135 may focus the pulsed laser beam 112 into the pulsed laser beam focal line 113. For example, an aspheric optical element may both transform pulsed laser beam 112 into a quasi-non-diffracting laser beam and focus the quasi-non-diffracting laser beam into pulsed laser beam focal line 113.

Referring again to FIGS. 3-5, the pulsed beam source 110 is configured to output pulsed laser beam 112. In operation, the defects 172 of the contour 170 are produced by interaction of the transparent workpiece 120 with the pulsed laser beam 112 output by the pulsed beam source 110 as modified by the aspheric optical element 135 and/or lens assembly 130. In operation, the pulsed laser beam 112 output by the pulsed beam source 110 may induce multi-photon absorption (MPA) in the transparent workpiece 120. MPA is the simultaneous absorption of two or more photons of identical or different frequencies that excites a molecule from one state (usually the ground state) to a higher energy electronic state (i.e., ionization). The energy difference between the involved lower and upper states of the molecule is equal to the sum of the energies of the involved photons. MPA, also called induced absorption, can be a second-order or third-order process (or higher order), for example, that is several orders of magnitude weaker than linear absorption. It differs from linear absorption in that the strength of second-order induced absorption may be proportional to the square of the light intensity, for example, and thus it is a nonlinear optical process.

In some embodiments, the pulsed beam source 110 may output a pulsed laser beam 112 comprising a wavelength of, for example, 1064 nm, 1030 nm, 532 nm, 530 nm, 355 nm, 343 nm, or 266 nm, or 215 nm. Further, the pulsed laser beam 112 used to form defects 172 in the transparent workpiece 120 may be well suited for materials that are transparent to the selected pulsed laser wavelength. Suitable laser wavelengths for forming defects 172 are wavelengths at which the combined losses of linear absorption and scattering by the transparent workpiece 120 (e.g., after propagation through the textured surface 123) are sufficiently low. In embodiments, the combined losses due to linear absorption and scattering by the transparent workpiece 120 at the laser wavelength are less than 20%/mm, or less than 15%/mm, or less than 10%/mm, or less than 5%/mm, or less than 1%/mm, such as 0.5%/mm to 20%/mm, 1%/mm to 10%/mm, or 1%/mm to 5%/mm, for example, 1%/mm, 2.5%/mm, 5%/mm, 10%/mm, 15%/mm, or any range having any two of these values as endpoints, or any open-ended range having any of these values as a lower bound. As used herein, the dimension “/mm” means per millimeter of distance within the transparent workpiece 120 in the beam propagation direction of the pulsed laser beam 112 (i.e., the Z-direction). Representative laser wavelengths for many glass workpieces include fundamental and harmonic wavelengths of Nd³⁺ (e.g. Nd³⁺:YAG or Nd³⁺:YVO₄ having fundamental wavelength near 1064 nm and higher order harmonic wavelengths near 532 nm, 355 nm, and 266 nm). Other laser wavelengths in the ultraviolet, visible, and infrared portions of the spectrum that satisfy the combined linear absorption and scattering loss requirement for a given substrate material can also be used.

Referring still to FIGS. 3-5, in operation, the contour 170 may be formed in the transparent workpiece 120 by irradiating a contour line 142 with the pulsed laser beam 112 and translating at least one of the pulsed laser beam 112 and the transparent workpiece 120 relative to each other along the contour line 142 in the translation direction 101 to form the defects 172 of the contour 170. While the contour 170 depicted in FIG. 3 is linear, it should be understood that the contour 170 may be non-linear, for example, curved. Further, in some embodiments, the contour 170 may be a closed contour, such as a circle, rectangles, ellipses, squares, hexagons, ovals, regular geometric shapes, irregular shapes, polygonal shapes, arbitrary shapes, and the like. In embodiments, the contour line 142 represents a boundary between a used portion of the transparent workpiece 120 (e.g., incorporated into a glass article) and a discarded portion of the transparent workpiece 120.

Directing or localizing the pulsed laser beam 112 into the transparent workpiece 120 generates an induced absorption (e.g., MPA) within the transparent workpiece 120, and deposits enough energy to break chemical bonds in the transparent workpiece 120 at spaced locations along the contour line 142 to form the defects 172. According to one or more embodiments, the pulsed laser beam 112 may be translated across the transparent workpiece 120 by motion of the transparent workpiece 120 (e.g., motion of a translation stage 190 coupled to the transparent workpiece 120), motion of the pulsed laser beam 112 (e.g., motion of the pulsed laser beam focal line 113), or motion of both the transparent workpiece 120 and the pulsed laser beam focal line 113. By translating at least one of the pulsed laser beam focal line 113 relative to the transparent workpiece 120, the plurality of defects 172 may be formed in the transparent workpiece 120.

In some embodiments, the defects 172 may generally be spaced apart from one another by a distance along the contour 170 of from 0.1 μm to 500 μm, such as, 1 μm to 200 μm, 2 μm to 100 μm, or 5 μm to 20 μm, 0.1 μm to 50 μm, 5 μm to 15 μm, 5 μm to 12 μm, 7 μm to 15 μm, 8 μm to 15 μm, or 8 μm to 12 μm, such as 50 μm or less, 45 μm or less, 40 μm or less, 35 μm or less, 30 μm or less, 25 μm or less, 20 μm or less, 15 μm or less, 10 μm or less, such as 100 μm, 75 μm, 50 μm, 40 μm, 30 μm, 25 μm, 10 μm, 5 μm, or any range having any two of these values as endpoints, or any open-ended range having any of these values as a lower bound. While not intending to be limited by theory, increasing the spacing distance between adjacent defects 172 may increase the processing speed (i.e., reducing processing time) and decreasing the spacing distance between adjacent defects 172 may reduce the break resistance of the contour 170 of defects 172. Further, the translation of the transparent workpiece 120 relative to the pulsed laser beam 112 may be performed by moving the transparent workpiece 120 and/or the pulsed beam source 110 using one or more translation stages 190.

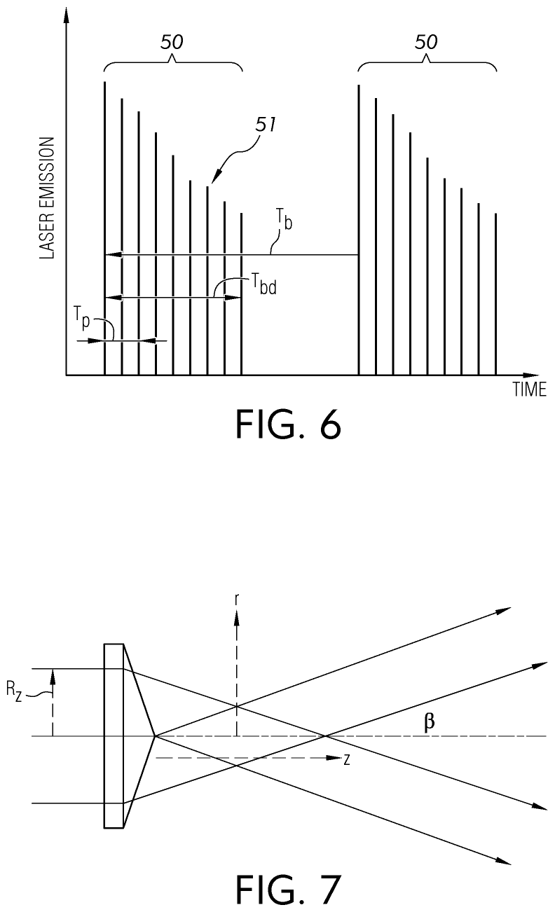

Referring now to FIGS. 3-6, in embodiments, the defects 172 of the one or more contours 170 are formed with pulse bursts 50 having at least two sub-pulses 51. In such embodiments, the force necessary to separate the transparent workpiece 120 along contour 170 (i.e. the break resistance) is reduced compared to the break resistance of a contour 170 of the same shape with the same spacing between adjacent defects 172 in an identical transparent workpiece 120 that is formed using a single pulse laser having the same energy as the combined energies of the sub-pulses of the pulse burst 50. A pulse burst (such as pulse burst 50) is a short and fast grouping of sub-pulses (i.e., a tight cluster of sub-pulses, such as sub-pulses 51) that are emitted by the laser and interact with the material (i.e. the transparent workpiece 120). The use of pulse bursts 50 (as opposed to a single pulse operation) increases the size (e.g., the cross-sectional size) of the defects 172, which facilitates the connection of adjacent defects 172 when separating the transparent workpiece 120 along the contour 170, thereby minimizing crack formation away from contour 170 in the separated sections of the transparent workpiece 120.

Referring still to FIGS. 3-6, in some embodiments, pulses produced by the pulsed beam source 110 are produced in pulse bursts 50 of two sub-pulses 51 or more per pulse burst 50, such as from 2 to 30 sub-pulses 51 per pulse burst 50 or from 5 to 20 sub-pulses 51 per pulse burst 50. Furthermore, the energy required to modify the transparent workpiece 120 is the pulse energy, which may be described in terms of pulse burst energy (i.e., the energy contained within a pulse burst 50 where each pulse burst 50 contains a series of sub-pulses 51; that is, the pulse burst energy is the combined energy of all sub-pulses within the pulse burst). The pulse energy (for example, pulse burst energy) may be from 25 μJ to 1000 μJ or 25 μJ to 750 μJ, such as from 1000 to 600 μJ, 50 μJ to 500 μJ, or from 50 μJ to 250 μJ, for example, 25 μJ, 50 μJ, 75 μJ, 100 μJ, 200 μJ, 250 μJ, 300 μJ, 400 μJ, 500 μJ, 600 μJ, 750 μJ, or any range having any two of these values as endpoints, or any open-ended range having any of these values as a lower bound.

Referring now to FIG. 7, to form a Bessel beam, a conical wavefront is created, typically by employing an axicon with an optical axis aligned with the direction of beam propagation and centered with respect to the intensity profile of the incoming laser beam. This imparts a phase delay to the incoming wavefront of an incoming laser beam that is linearly proportional to the distance from the optical axis. Such an axicon may be refractive optic, a reflective optic, a phase-plate element, or a diffractive optic.

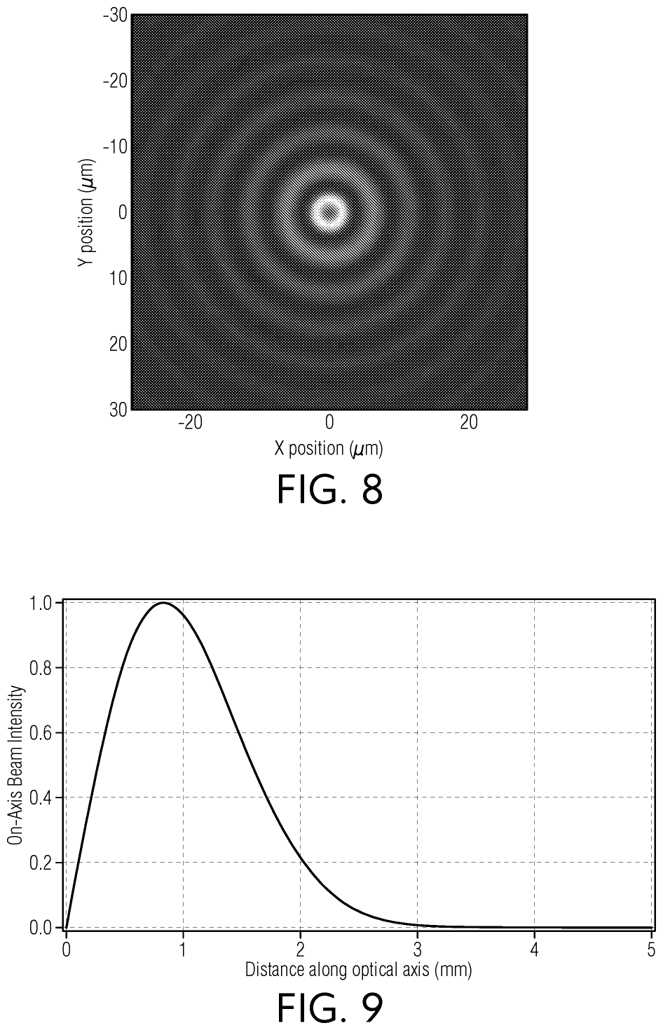

Referring now to FIGS. 8 and 9, the interference of the conical wavefronts will cause any cross sectional profiles of the beam emerging from the axicon to be modulated with a Bessel function-like dependence, with the exact roll off in intensity with radius (direction normal to the direction of beam propagation) and in the z-distance (direction of beam propagation) depending on the nature of the beam illuminating the axicon. The input beam illuminating the axicon most commonly has a Gaussian cross section intensity profile. In that case, the beam emerging from the axicon is a type of Bessel beam referred to herein as a “Gauss-Bessel beam.”

The focus formed is referred to as a “focal line” or “line focus.” Important properties of the focal line are its core diameter and its length.

The numerical aperture NA for s focusing laser beam is given by Equation (A), below:

NA=n*sin(β) (A)

where n is the refractive index of the medium (i.e., air), and β is the maximum ray angle in the cone of light being focused, measured with respect to the axis of propagation of the beam. Note in the context of a laser beam, “numerical aperture” is defined by the beam of light actually propagating through and being focused by the optics, not by the maximum physical diameter of the optic itself. Hence, if the physical size of the optic is increased in diameter, but the size of the laser beam propagating through the optic is not altered, then the numerical aperture of the focused laser beam remains the same.

The relationship between the numerical aperture NA of the focused rays and the core diameter d of a Bessel beam is governed by the Equation (B), below:

$$d = 2 \frac{2.405 {λ}_{o}}{NA 2 π {n}_{o}} \qquad ( B )$$

where λ₀ is the wavelength of the light source, and n₀ is the refractive index of the medium, which is about 1.0 for air. The core diameter d is the diameter of the first null in the Bessel function cross section of the beam. Hence, this formula indicates that the focused core is simply a function of the wavelength and the numerical aperture. Conventionally, when Bessel beam cutting of glass is performed, a numerical aperture of 0.25-0.45 is used. At the commonly used wavelengths of 1030 nm and 1064 nm, high short-pulse (ns, ps, or fs) laser pulse energies may be readily achieved. This means that core diameters of 3.25 microns-1.8 microns are used.

As can be seen from Equation (B), a lower numeral aperture will create a large core diameter. This decreases the energy density in the material, which should be considered when forming strong laser modification (nano-perforation) through the complete thickness of the substrate.

The input beam illuminating the axicon may have a Gaussian cross-sectional profile. The intensity is highest at the center of the beam, that is along the beam propagation axis, and decays radially. In this case, the Gauss-Bessel beam emerging from the axicon will have an on-axis intensity distribution in the direction of beam propagation (FIG. 9). Distance of 0 mm in FIG. 9 corresponds to the exit surface of the axicon. The on-axis intensity distribution of the Gauss-Bessel beam has a peak normalized intensity of 1 as shown in FIG. 9 and exhibits a fast rise to a peak and then slower decay with distance after the peak. The distance L between the points along the direction of beam propagation at which the intensity has decreased to 50% of the peak intensity may be approximated by Equation (C), below:

L˜0.8*R_{z}/sin(β) (C)

L in Equation (3) is effectively the length (or extent along the optical axis) of the line focus. It is a function of both the input Gaussian beam size (1/e² radius, R_{z}) and the aperture angle β (FIG. 7).

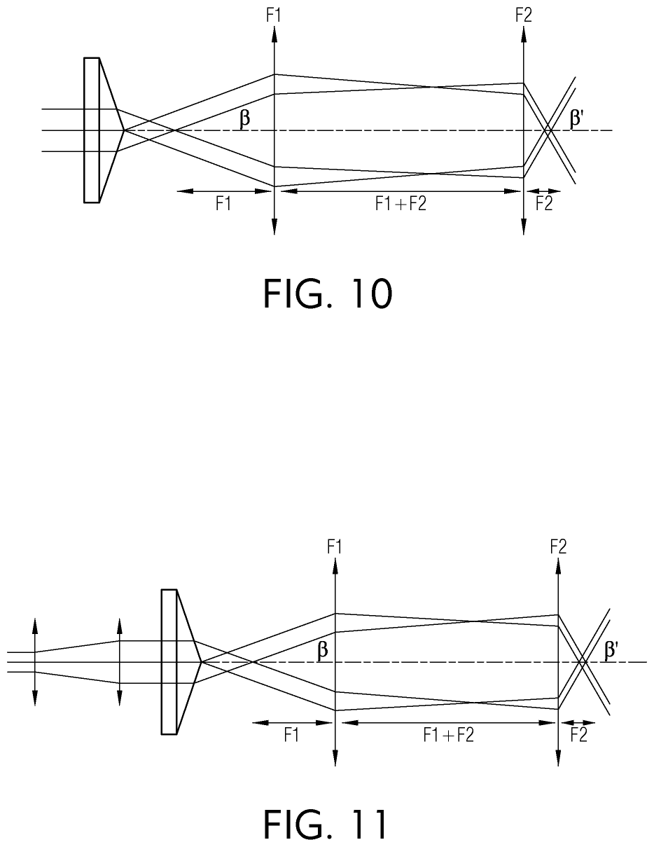

Referring now to FIG. 10, an optical design where the line focus generated by an axicon is magnified by a 2F/2F pair of objective lenses (e.g., a telescope) is shown. This optical system may be used to produce Bessel beams for glass cutting. The magnification of the telescope located after (downstream from) the axicon is given by M=F2/F1, which may then be varied by changing the focal length F1 or the focal length F2. The numerical aperture of the Bessel beam emerging from the telescope will scale with the magnification of the telescope. Commensurately, this means that the lateral profile of the focused Bessel beam (diameter) in a given plane along the Z-direction scales linearly with the magnification of the telescope. However, as derived from the axial magnification properties of telescopes as known in the art generally, it should be noted that the length of the line focus is scales with the square of the magnification.

Referring now to FIG. 11, an embodiment that includes magnification of the size (1/e² radius, R_{z}) of the input Gaussian beam by a factor of N upstream of the axicon is shown. With the configuration shown in FIG. 11, per Equations (B) and (C), the only key output parameter that is affected by a change in the size (1/e² radius, R_{z}) of the input Gaussian beam is the length of the line focus, which increases linearly with the input Gaussian beam magnification N (the ratio of size (1/e² radius, R_{z}) of the input beam at the surface of incidence of the axicon to the size (1/e² radius, R_{z}) of the beam produced by the laser source). Since the numerical aperture of the focused light is unchanged, as seen from Equation (B), the diameter of the line focus is left unaffected. In contrast, when Gaussian laser beams unmodified by an axicon are used, depth-of-focus (Rayleigh range) and focused core diameter are inherently coupled, and cannot be independently varied. The use of an input telescope to modify the input Gaussian beam size (1/e² radius, R_{z}) is a convenient way for controlling a line focus (Bessel-like) cutting/drilling system, as it allows changes of only the line focus length while leaving the core diameter unchanged. In order to set the line length to be suitable for processing the textured glass substrates of ˜2.5-3 mm thickness with Gauss-Bessel beams of different numerical apertures, in some embodiments the input Gaussian beam size used was as large as 2.75 mm (1/e² radius, R_{z}), in others it was made to be 2.5 mm, and in some cases it was made as small as 1.5 mm.

In one example, an optical setup employed a 1064 nm laser with a Gaussian beam profile incident on an axicon that was manufactured with a 9.615 deg cone angle. The Gauss-Bessel beam emerging from the axicon was directed to a telescope. The first lens (F1) of the telescope consisted of a pair of elements that had a combined effective focal length of 134 mm. This created an annular ring of light of diameter about 22 mm at the second lens F2 of the telescope. For the lens F2, various focal lengths were employed to transform the annular ring produced by first lens F1 into a focused Gauss-Bessel beam. The various focal lengths of the lens F2 provided different telescope magnifications and thus focused Gauss-Bessel beams with different numerical apertures. In each instance, second lens F2 was separated from first lens F1 by a distance equal to the sum of the effective focal length of first lens F1 and the focal length of second lens F2. Table 1 details the set of optical configurations explored. Telescope magnification refers to the ratio of the focal length of second lens F2 to the effective focal length (134 mm) of first lens F1. Final Beam NA refers to the numerical aperture of the beam produced by second lens F2 and is determined by Equation (A) in which the medium is air (refractive index=1) and β is the cone angle of the axicon (9.615 deg). Core diameter is determined by Equation (B) in which the medium is air (refractive index=1).

TABLE 1

| F2 focal | | Final | Core diameter |
|---|---|---|---|
| length | Telescope | Beam | in air |
| (mm) | Magnification | NA | (microns) |
| 30 | 0.22 X | 0.37 | 2.28 |
| 40 | 0.30 X | 0.275 | 3.05 |
| 50 | 0.37 X | 0.22 | 3.81 |
| 58 | 0.43 X | 0.19 | 4.42 |
| 77 | 0.57 X | 0.14 | 5.86 |

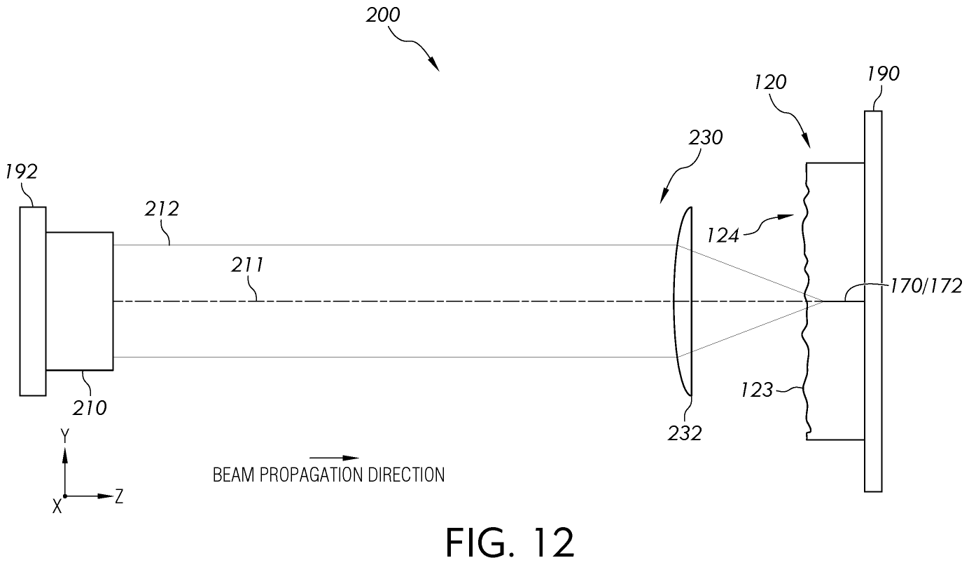

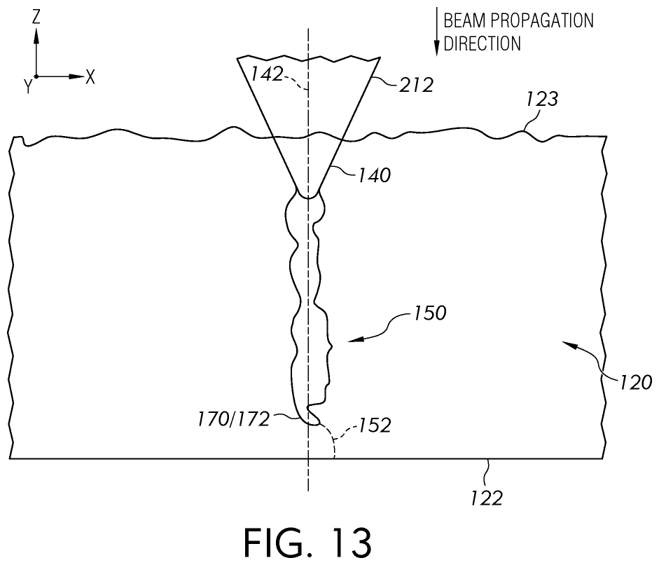

Referring now to FIGS. 12 and 13, after forming the contour 170 of defects 172 along the contour line 142 in the transparent workpiece 120 using, for example, one of the embodiments according to FIGS. 3-6, the transparent workpiece 120 may be further acted upon in a subsequent separating step to induce separation of the transparent workpiece 120 along the contour line 142 (i.e., along the contour 170 of defects 172). In embodiments, the subsequent separating step includes directing an infrared laser beam 212 onto the transparent workpiece 120 to apply a thermal stress to the transparent workpiece 120. The applied thermal stress induces separation that extends between adjacent defects 172 in the transparent workpiece 120 along the contour line 142. In the transparent workpiece 120, this separating may include propagation of a crack along the contour line 142.

Without being bound by theory, the infrared laser beam 212 is a controlled heat source that rapidly increases the temperature of the transparent workpiece 120 at or near the contour line 142, modifying material of the transparent workpiece 120 along or near the contour line 142 to induce separation of the material extending between adjacent defects 172. In addition, this rapid heating may build compressive stress in the transparent workpiece 120 on or adjacent to the contour 170. Since the area of the heated surface of transparent workpiece 120 is relatively small and shallow when compared to the overall surface area of the transparent workpiece 120, the heated area cools relatively rapidly. The resultant temperature gradient induces tensile stress in the transparent workpiece 120 sufficient to propagate a crack along the contour 170 and through the depth of the transparent workpiece 120, resulting in full separation of the transparent workpiece 120. Without being bound by theory, it is believed that the tensile stress may be caused by expansion of the glass (i.e., changed density) in portions of the workpiece with higher local temperature induced by infrared laser beam 212.

FIG. 12 depicts an optical assembly 200 comprising an infrared beam source 210 configured to generate the infrared laser beam 212. The infrared beam source 210, which may comprise a carbon dioxide laser (a “CO₂ laser”), a carbon monoxide laser (a “CO laser”), a solid-state laser, a laser diode, or combinations thereof. The infrared laser beam 212 comprises a wavelength that is readily absorbed by the transparent workpiece 120, for example, a wavelength ranging from 1.2 μm to 13 μm, such as, a range of 4 μm to 12 μm. The power of the infrared laser beam 212 may be from about 10 W to about 4000 W, for example 100 W, 250 W, 500 W, 750 W, 1000 W, or the like. Further, the infrared beam source 210 may comprises a continuous wave laser or a pulsed laser. The optical assembly 200 further comprises a lens assembly 230 that includes a lens 232 for concentrating the infrared laser beam 212, to create a specific core diameter (twice the 1/e² radius or equivalent) on the transparent workpiece 120. The core diameter at the surface of the workpiece is generally greater than or equal to 1 mm and less than or equal to 15 mm, such as greater than or equal to 2 mm and less than or equal to 10 mm, or greater than or equal to 4 mm and less than or equal to 8 mm. It is desirable to keep the spot size small enough such that the local temperature of the glass is significantly increased and thermal stress is generated and a crack generated, but to not make the spot size so small and laser intensity so high that the glass is locally ablated or damaged in an uncontrolled manner. The infrared laser spot is made to traverse along the defect contour 170, which propagates a crack from one defect 172 to the next. The infrared beam spot size at the transparent workpiece 120, and available infrared laser power dictate the speed at which the infrared laser beam 212 may be translated to affect such crack propagation, with higher speeds being enabled by higher laser powers. In operation, the infrared laser beam 212 propagates along an infrared beam pathway 211 and is oriented such that the infrared laser beam 212 may be directed onto the transparent workpiece 120, for example, and formed into a desired spot size on the textured surface 123 of the transparent workpiece 120 using the lens 232.

Referring now to FIG. 13, a cross section of the transparent workpiece 120 with a contour 170 of defects 172 during laser processing with the infrared laser beam 212 is schematically depicted. In FIG. 13, the infrared laser beam 212 is directed onto the transparent workpiece 120 using the optical assembly 200 of FIG. 12 and comprises a Gaussian intensity profile at the transparent workpiece 120. In addition, in FIG. 13, the infrared laser beam 212 is directed onto the transparent workpiece 120 in alignment with the contour 170 of defects 172 and thus in alignment with the contour line 142. Because the infrared laser beam 212 comprises a Gaussian energy distribution, interaction of the infrared laser beam 212 with the transparent workpiece 120 forms a thermal affected area 140. The thermal affected area 140 corresponds to the portions of transparent workpiece 120 that absorb the infrared laser beam 212 and receive sufficient energy to produce thermal stresses sufficient to induce separation of transparent workpiece 120 along the contour 170. That is, the thermal affected area 140 comprises a portion the transparent workpiece 120 into which thermal energy sufficient to induce separation of the contour 170 of defects 172 is applied. In embodiments, the thermal affected area 140 induces propagation of a crack 150 in the transparent workpiece 120. In the depicted example, the crack 150 extends through an entirety of the thickness of the transparent workpiece 120 such that the thermal affected area 140 is sufficient to induce separation of the transparent workpiece 120 along the crack 150.

As depicted in FIG. 13, the defects 172 formed as a result of the process described herein with respect to FIGS. 3-6 do not always extend through the entirety of the transparent workpiece 120. Such defects 172 may result even if the pulsed laser beam focal line 113 possesses a length that is greater than the thickness of the transparent workpiece 120. For example, the textured surface 123 may distort and scatter the pulsed laser beam focal line 113, thereby modifying the energy density distribution of the pulsed laser beam focal line 113. As a result of such distortion, after traveling through a portion of the transparent workpiece 120, the pulsed laser beam focal line 113 may not possess the requisite energy density to modify the transparent workpiece 120 such that at least a portion of the transparent workpiece 120 is not modified by the pulsed laser beam focal line 113. Such an unmodified portion of the transparent workpiece 120 renders the propagation of the crack 150 unpredictable. In the example, the crack 150 significantly deviates from the contour 170 in the portion of the transparent workpiece 120 to which the depicted defect 172 does not extend.

Distortions of the pulsed laser beam focal line 113 caused by the textured surface 123 may also cause the defects 172 to possess a non-uniform cross-sectional shape (e.g., the X-Y plane) as a function of distance from the (e.g., in the Z-direction) from the textured surface 123. Such cross-sectional deviations may cause the crack 150 to propagate between adjacent ones of the defects 172 (e.g., separated in the Y-direction in the example depicted) in a manner that deviates from the contour 170. As a result, while the application of the infrared laser beam 212 may result in separation of the transparent workpiece 120, the line of separation (e.g., the crack 150) may significantly depart from the contour 170 in an unpredictable manner. Such unpredictability results in process waste because the transparent workpiece 120 may be processed using a contour providing allowances for such crack deviations.

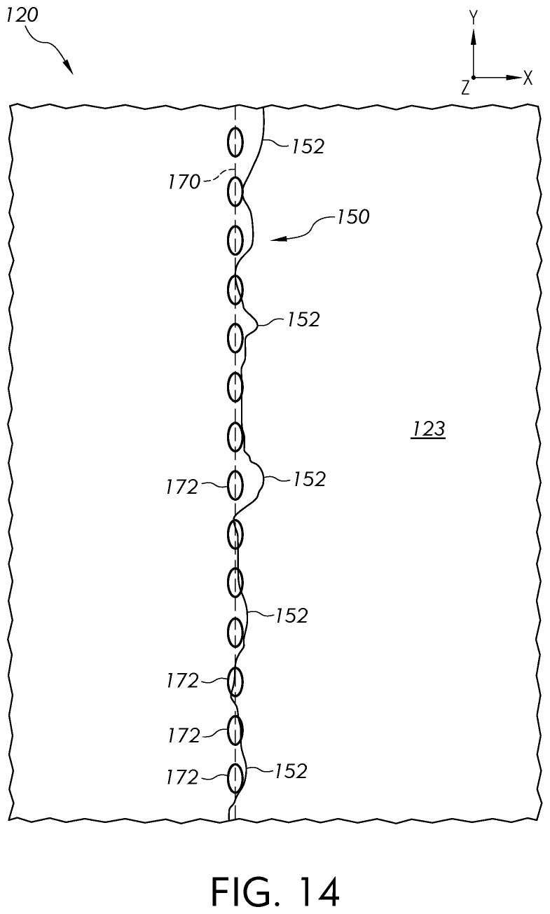

FIG. 14 depicts a perspective view of the transparent workpiece 120 during separation thereof. As depicted the transparent workpiece 120 includes a plurality of defects 172. At the textured surface 123, the plurality of defects 172 possess an elliptical cross-section (e.g., in the X-Y plane). For example, in embodiments, the optical assembly 100 described herein with respect to FIG. 5 may impart an elliptical cross-sectional shape on the pulsed laser beam 112 such that the pulsed laser beam focal line 113 has an elliptical cross-section in the X-Y plane. In embodiments, the plurality of defects 172 may possess an alternative shape (e.g., possessing an asymmetry such that the defects 172 are greater in size along the direction of extension of the contour 170, or in the Y-direction of FIG. 14). In the depicted example, the defects 172 have a major axis extending along the contour 170. Defects 172 possessing such a shape beneficially guide propagation of a crack 150 induced by stress (e.g., via the infrared laser beam 212 described with respect to FIGS. 12 and 13) along the contour 170, thereby reducing the threshold amount of stress to induce crack propagation. Guiding propagation of the crack 150 along the contour 170 also beneficially improves edge strength of a separated portion of the transparent workpiece 120 by reducing an amount that the crack 150 propagates in a direction perpendicular to the contour 170 (e.g., in the X-direction).

However, as described herein with respect to FIG. 13, the textured surface 123 may modify the cross-sectional shape of the pulsed laser beam focal line 113 as the pulsed laser beam focal line 113 propagates through the transparent workpiece 120. As a result, the defects 172 may not possess the elliptical profile depicted in FIG. 14 in regions of the transparent workpiece 120 beneath the textured surface 123. Such cross-sectional deviations may diminish the crack-guiding propensity of the defects 172, causing deviations 152 in the crack 150 in a direction (e.g., the X-direction) that is perpendicular to the contour 170. As such, the textured surface 123 may result in the transparent workpiece 120 separating along a line of separation that significantly deviates from an intended line of separation. Additionally, the plurality of defects 172 may not extend through an entirety of the thickness of the transparent workpiece 120. As a result, propagation of the crack 150 through the thickness of the transparent workpiece 120 (e.g., in the Z-direction) may also deviate from the contour 170.

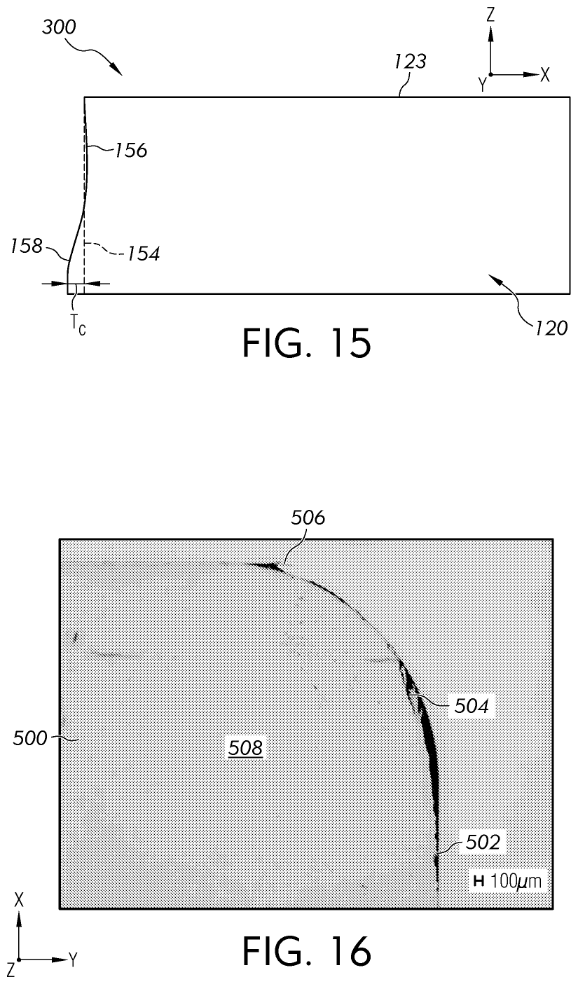

FIG. 15 depicts a cross-sectional view of a separated portion 300 of the transparent workpiece 120. For example, the separated portion 300 may result from separating the transparent workpiece 120 described with respect to FIG. 14 along the crack 150. The separated portion 300 includes a cut edge 156 that may correspond to the crack 150. The cut edge 156 includes a cantilever curl 158 where the cut edge 156 deviates from a desired line of separation 154 by a thickness T_{c}. The cantilever curl 158 results from the defect 172 not extending through the entirety of the thickness of the transparent workpiece 120 and failing to guide the crack 150 when the crack 150 propagates through the thickness of the transparent workpiece 120. In examples, the thickness T_{c} of the cantilever curl in the direction perpendicular to the desired line of separation 154 may be greater than or equal to 100 μm (e.g., greater than or equal to 100 μm and less than or equal to 150 μm). As such, significant amounts of post-processing may be required to provide a cut edge 156 that corresponds to the desired line of separation 154. Given the potential for such large deviations from the desired line of separation 154, laser processing of the transparent substrate 120 by directing the pulsed laser beam 112 directly onto the textured surface 123 may utilize contour lines that are significantly offset from the desired line of separation 154, increasing material waste.

As another example, FIG. 16 depicts a top view of a separated portion 500 of a transparent workpiece processed via the laser processing methods described herein. The separated portion 500 includes a textured surface 508 and a cut edge 502 including a curved contour. As a result of defects produced with laser processing method described herein not extending through an entirety of the thickness of the separated portion 500, the cut edge 502 includes chips 504 where the cut edge 502 extends inward from the curved contour by approximately 100 μm and adhered glass 506 extending outward from the curved contour by approximately 150 μm. Such chips 504 and adhered glass 506 may particularly result from contours where the contour direction changes rapidly with location, such as curved contours having a radius of curvature of less than or equal to 10 mm. To provide the separated portion 500 with a relatively strong outer edge at the cut edge 502, the cut edge 502 may be subjected to grinding and polishing to remove the chips 504 and the adhered glass 506. Removing upwards of 100 μm of material from the cut edge 502 represents an amount of material removal that significantly exceeds typical sub-surface damage associated with laser processing of transparent substrates (e.g., less than or equal to 30 μm). As such, textured surfaces may cause additional material waste when curved contours are desired.

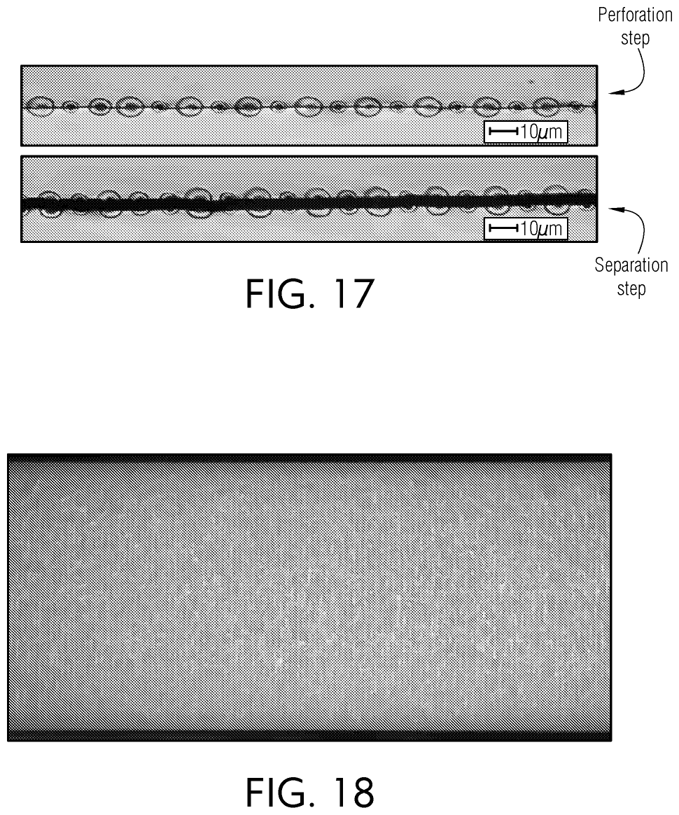

Referring now to FIGS. 17 and 18, by traversing the laser beam across a glass sheet and emitting laser pulses at controlled times, these nano-perforations are strung together to trace out the contour of a desired part. The spacing between the nano-perforation is typically from a few microns up to a few tens of microns, and may be formed at a rate of hundreds of thousands per second. The nano-perforations serve as sites that both initiate and guide crack propagation in the glass sheet. Once stress is applied, the glass sheet will separate along the nano-perforated contour.

Stress may be applied by mechanically bending the sheet, or by applying thermally induced stress. A preferred way of applying thermal stress is to trace the nano-perforated contour using a mid-infrared laser, such as a CO₂ laser, as described above. The mid-infrared light is absorbed at the surface of the glass, and creates local heating. This heat creates local expansion of the glass sheet, which propagates the crack along the nano-perforation sites, separating the glass into discrete pieces. The CO₂ laser spot size and dwell time at any given location must deposit enough energy to generate sufficient thermal stress to propagate the crack, but not so much energy that it causes melting, ablation, or other undesired damage to the glass surface. A typical process entails focusing a duty cycle modulated or continuous wave laser beam with of 50-400 W (e.g., 200 W) optical power into a 1-15 mm diameter (1/e²) spot size (e.g., 6 mm) at the glass surface, and traversing the spot around the nano-perforated contour at speeds of 50-1000 mm/sec (e.g., 200 mm/sec).

For the best results, the nano-perforation should satisfy two conditions. First, the cracks emerging from each nano-perforation site should be directed towards the adjacent nano-perforations. In other words, even at a sub-millimeter scale (100 μm scale), the cracks should follow the intended part contour, and not propagate into the body of the desired part. Second, the nano-perforations should extend through the full depth (thickness) of the transparent workpiece.

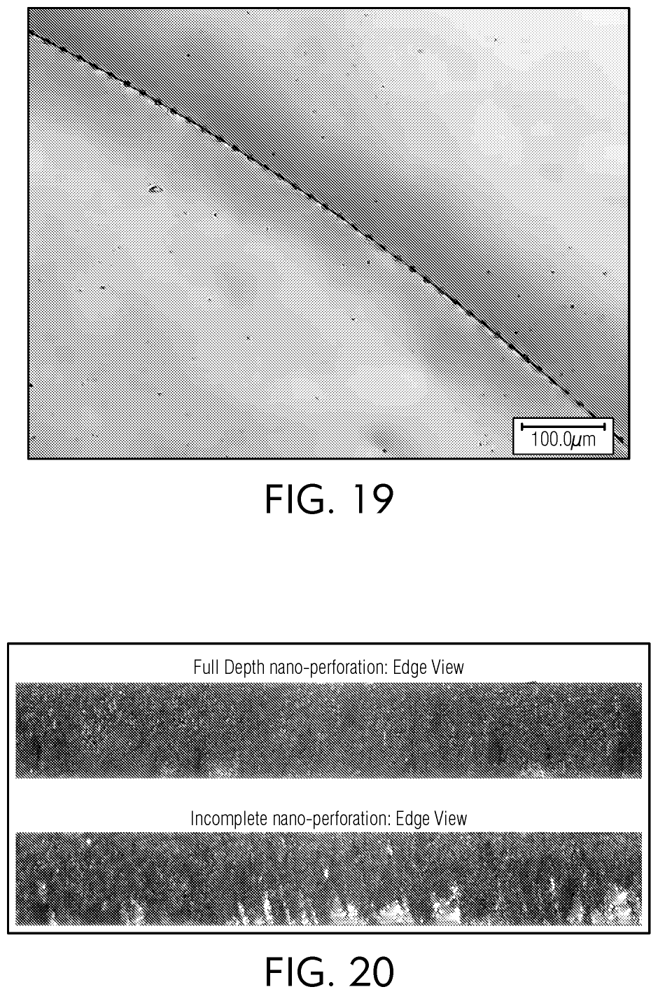

Referring now to FIG. 19, directing cracks towards the adjacent nano-perforations ensures that the crack propagates easily, meaning a minimal amount of stress can be applied to separate the glass pieces. It also ensures that the edge strength of the resulting separated part is high since cracks directed into the body of the part (perpendicular to the cut or separated edge) will fail at low applied stresses when the part is flexed or bent. Directing cracks toward adjacent nano-perforations may be achieved by imparting some asymmetry to the shape of the optical beam, for example by making the beam focus core take on an elliptical shape, or that of multiple spots aligned along a particular axis. Such asymmetry will cause the stress from each nano-perforation to be largest along a specific axis, so that cracks will preferentially align along a given direction. In the case of an elliptical spot, the cracks will generally align in the same direction as the major axis of the ellipse. This direction may be made to be parallel to the desired outer contour of the part. Methods of producing such asymmetric quasi-non-diffracting beams, as well as their benefits for lowering the stress to separate and increasing edge strength, are described in detail in U.S. Pat. Nos. 10,435,796 and 9,758,876 and U.S. Application Publication No. 2020/0061750, which are incorporated herein by reference.

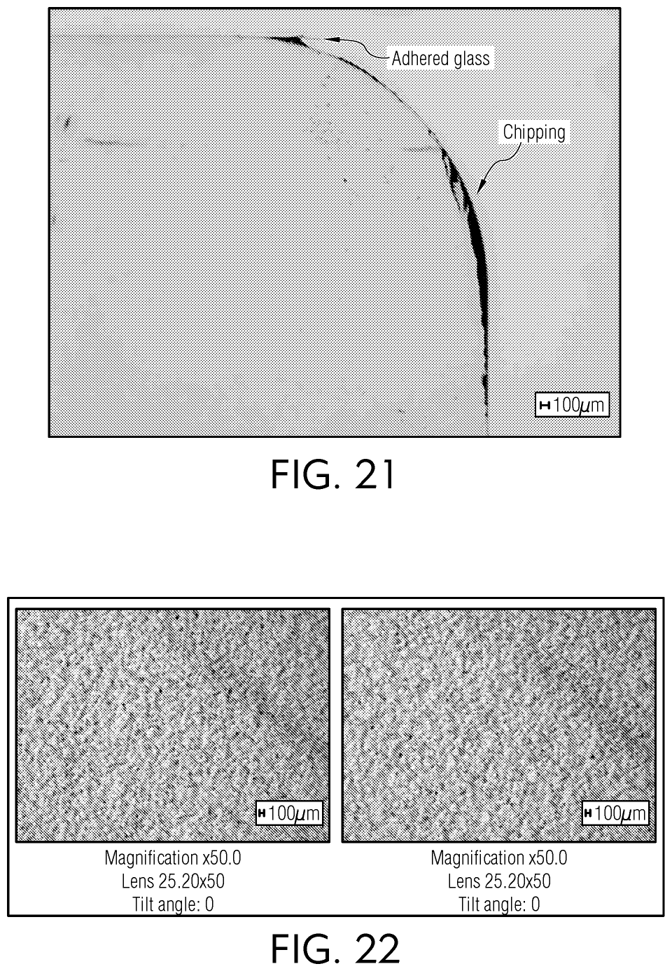

Referring now to FIGS. 20 and 21, nano-perforations extending through the full depth of the glass sheet ensures that the directed or guided crack follows the intended edge contour through the full thickness of the part. Incomplete nano-perforation may lead to sections of glass that separate in an uncontrolled or inconsistent manner. In the case of a straight line cut, generally the edge of the glass piece is intended to be a 90° edge—i.e. a single plane. These uncontrolled regions lead to deviations from that plane. In the case of separating the glass around a radiused contour, these deviations lead to sections of glass that may protrude from the intended radius (adhered glass), or be depressions into the intended part, which, if at the part surface, leads to chipping.

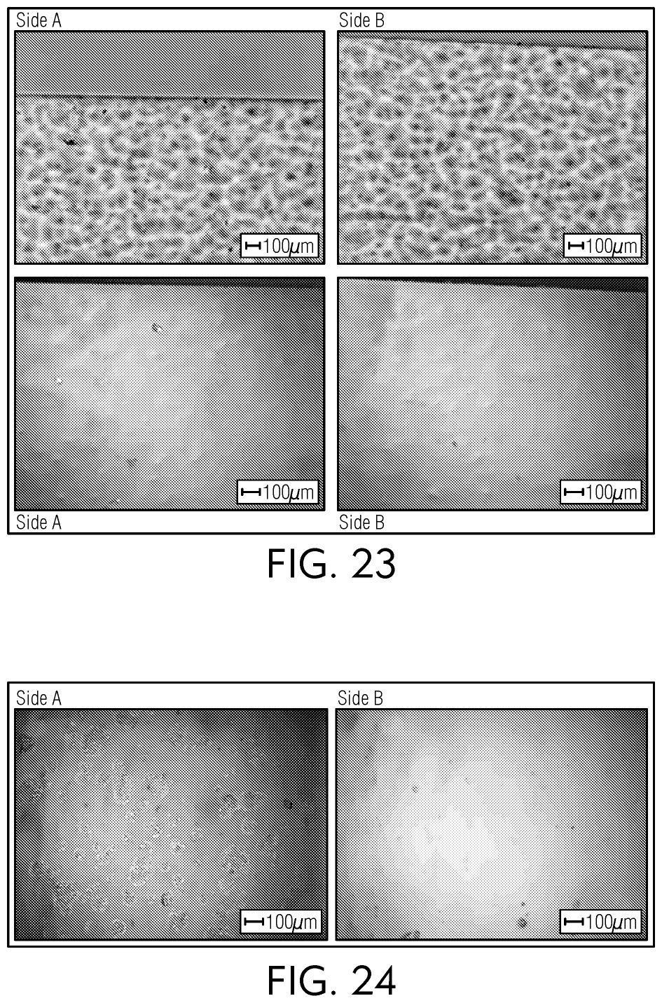

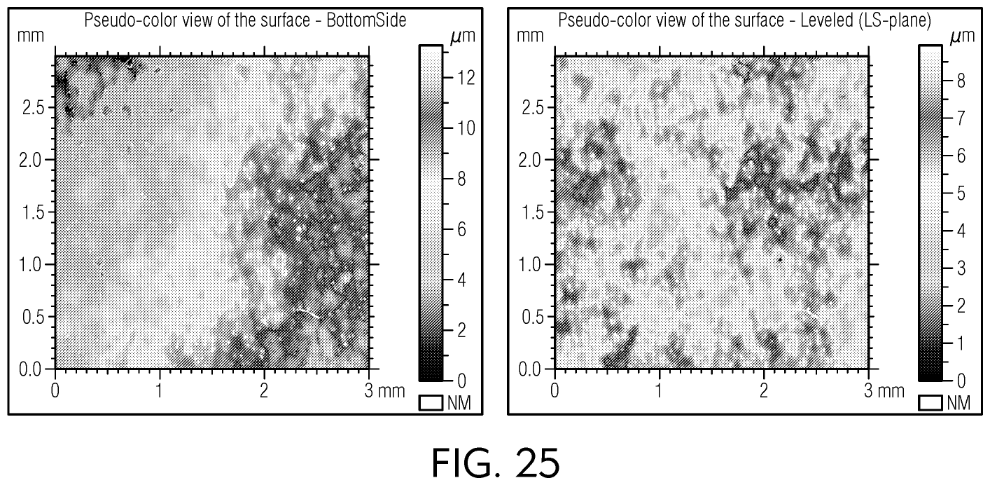

Referring now to FIGS. 22-25, textured glass substrates, such as those formed by a rolling process, are shown. Textured glass substrates may have a surface roughness Ra of about 0.5-5 μm. The surface roughness Ra may be mitigated by a light etch, with a surface removal of about 5 μm. However, such etching may increase cost and may not completely planarize the surface.

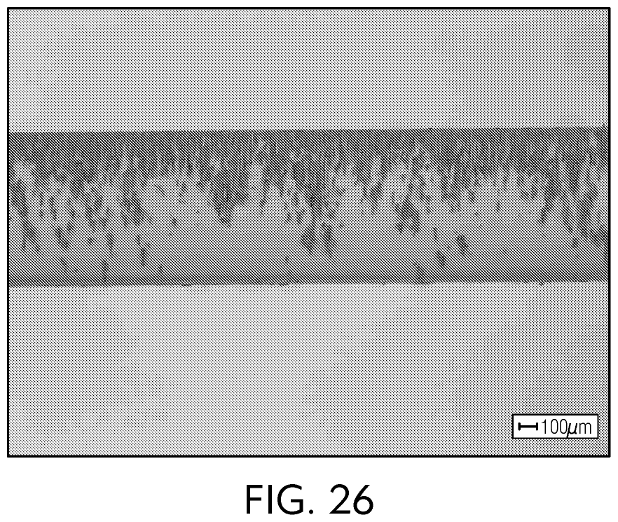

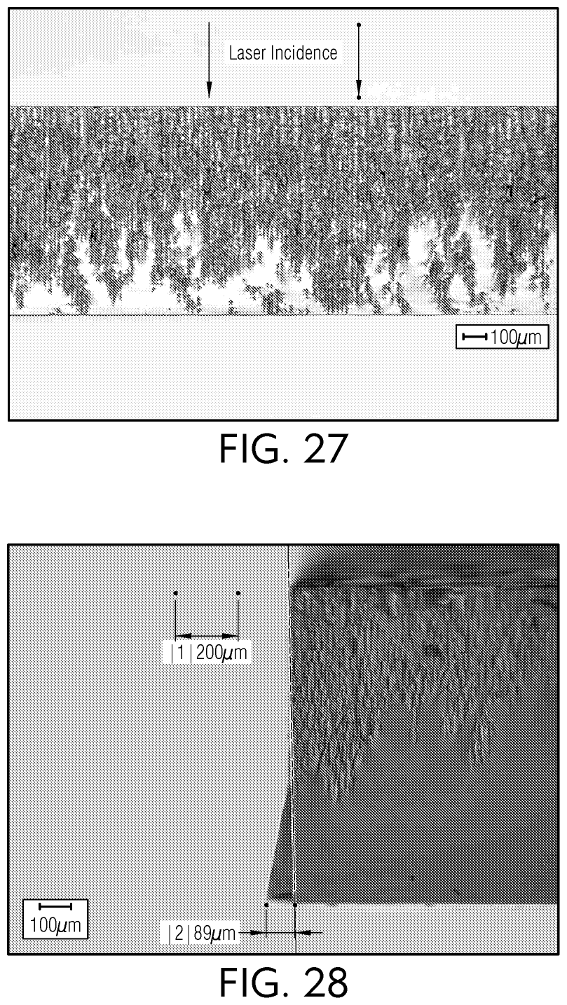

Due to the non-planar surfaces of textured glass substrates, light rays are deviated from their intended paths, and the focal line of the Bessel beam may fail to form with sufficient intensity. This effect is strongest for the rays that focus into the deepest sections of the glass. The focal line will generally form with sufficient intensity near the surface where the laser beam enters the glass sheet, but intensity may decay sharply as a function of depth, as shown in FIGS. 26 and 27. Even with such a partial body nano-perforation, the glass piece may still be separated. In fact, if the entrance surface is placed under tension, then no additional force may be required to separate the glass compared to a full body nano-perforation. However, the crack may no longer be well controlled through the full thickness of the glass. When stress is applied to separate the glass pieces, this lack of nano-perforation may lead to deviations in the glass edge from the desired straight edge.

Referring now to FIGS. 15 and 28, this deviation phenomenon is known as “cantilever curl.” This cantilever curl does not necessarily occur along the full length of the separated edge of the glass piece. It may vary in magnitude (distance from ideal straight edge) and height (depth at which it begins), with the variation being a strong function of the manner and consistency in which the mechanical or thermal separation stress is applied. With such a cantilever curl, the grind and polish that is required to achieve the final part shape is increased, as the magnitude of the removal must account for all variability in the part edge. For the glass thicknesses examined here (e.g., about 1.0 mm), the partial body nano-perforation may often lead to cantilever curl of about 100-150 μm. Requiring removal of this means about 5× extra removal compared to the requirements for removing just the sub-surface damage, thus reducing some of the economic advantages provided by laser cutting.

Referring now to FIG. 29, using multiple laser exposures at different focus heights still results in nano-perforations that do not extend through the thickness of the glass sheet, despite exhibit stronger laser damage. The surface texture still inhibited the beam from focusing well at the furthest depth of the glass sheet. Some damage was seen at the laser exit because the ablation threshold at the interfaces is generally less than the ablation threshold inside a glass sheet. Furthermore, multiple pass approaches also have the challenge that the nano-perforation from each pass may not be well aligned laterally, which may lead to variability in the crack direction or plane of separation.

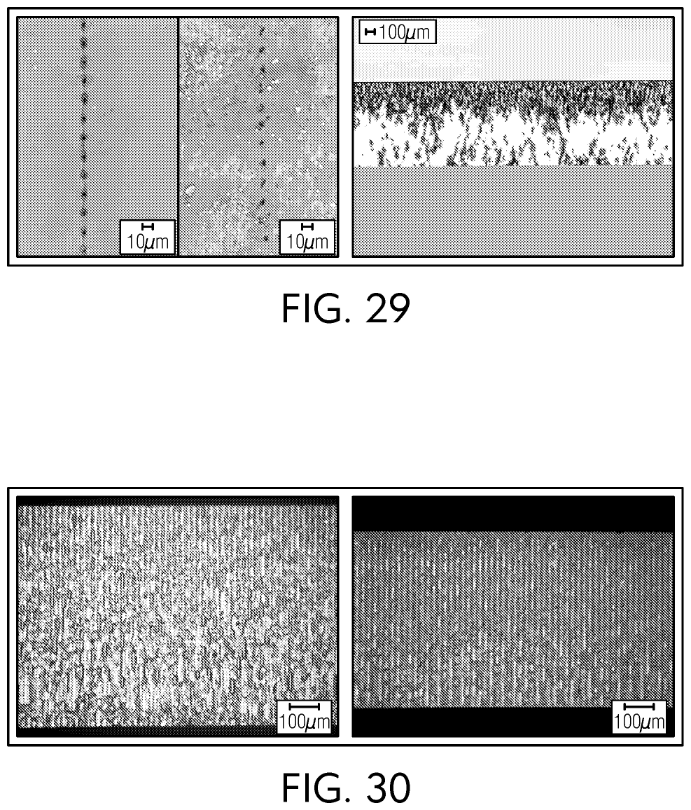

Referring now to FIG. 30, in one example, sample surfaces were mechanically polished and laser cut. The mechanical polish planarized the glass and removed any surface inclusions (e.g., boron nitride). The nano-perforations extended completely through the depth of the glass, exemplifying that the challenge of cutting textured glass substrates is due to surface effects, not volume or material effects. FIG. 30 also shows that laser focal line itself is sufficiently long and intense enough as to modify greater than 1 mm of material, provided that it does not become distorted by surface texture.

It should also be pointed out that the texture problem may not be easily solved by simply applying more laser energy. More laser energy does generate damage or nano-perforation further into the depth of the glass sheet. But to guide the crack optimally the line focus needs to both form a core of high intensity, but also preferably of proper cross sectional shape, such as an elliptical Bessel-like beam. The textured surface of the glass does not merely attenuate the energy, it distorts the beam. Hence, the light rays may no longer form the intended Bessel-like beam cross sectional profile. For textured glass, it is generally observed that the nano-perforation will be well formed and the crack well controlled near the incident surface of the glass sheet. But, at greater depths, e.g. 500 μm below the incident surface, there may be laser damage, but the nano-perforation may no longer exhibit the same shape/cross sectional profile. The core of the Bessel beam can be observed as breaking up into multiple spots due to optical aberrations, and the direction of the resulting crack emerging from each nano-perforation will become poorly controlled and no longer follow the intended part contour.

Moreover, the sidelobes of the Bessel-like beams may contain enough intensity to induce plasma absorption effects, and cause the resulting material modification to no longer be determined by the shape of the core (central lobe) of the beam. Having additional material damage from the sidelobes may make the crack difficult to control, as the effects are intensity dependent, and may occur more strongly or weakly, depending exact beam focus or depth into the material.

In view of the issues described herein, the laser processing method described herein allows the laser to fully perforate through the thickness of the textured glass, without requiring any additional steps (e.g., etching or coating), resulting in the ability to precisely cut near-net shape parts, whose edges have sub-surface damage of less than 30 μm allowing for much reduced grind and polish removal/time in downstream final part edge finishing steps.

In particular, a method of cutting textured glass includes using a low numerical aperture quasi-non-diffracting beam to nano-perforate through the coating into the glass, tracing a contour of a desired part. The glass is then separated around the nano-perforated contours by applying stress mechanically (e.g. bending) or thermally (e.g. with a CO₂ laser). The optical beam directed on the substrate should have a numerical aperture between 0.10 and 0.25, between 0.12 and 0.23, or even between 0.15 and 0.20. The beam may be incident on a material with a textured surface having a surface roughness (Ra) greater than 0.5 μm. The laser process may entail a single pass of the laser beam across the substrate, or multiple passes, each with a different focus setting.

In addition to textured glass substrates, the described method may also apply to cutting 3D formed glass or glass ceramic articles, where the substrate may have a smooth surface but local regions with a small radius of curvature (e.g., radius of curvature less than 20 mm, or less than 15 mm, or less than 10 mm, or less than 5 mm), which may inhibit standard nano-perforation cutting. The same numerical aperture ranges cited above enable strong nano-perforation throughout the thickness of the substrate in those highly curved regions.

Moreover, an article may include a cut sheet of glass that has a surface texture, but whose contour edges are defined nano-perforations that extend through the full thickness of the glass sheet. The surface texture (i.e., surface roughness Ra) of at least one side of the glass sheet may be greater than 0.5 μm. The textured glass sheet may also have boron nitride inclusions present at the surface of the glass. The sheet of glass may be greater than 1 mm thick.

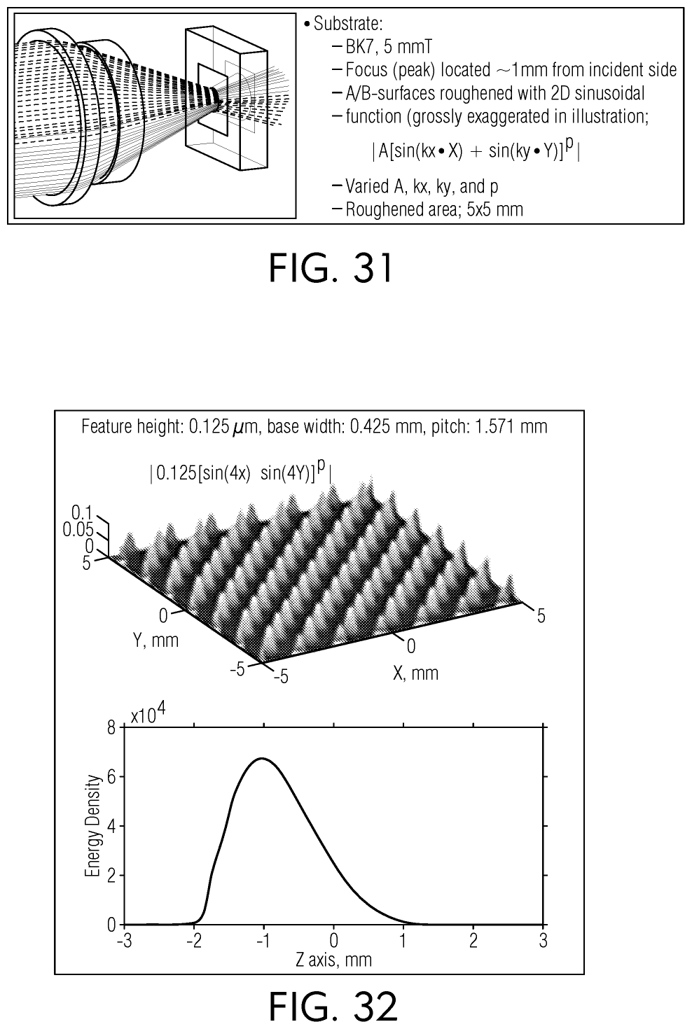

The textured surfaces of the rolled material comprise non-periodic deformations. The level of texture may be approximately the same from piece to piece, but exact surface deviations are local and irregular, so the changes in refraction imparted on each of the rays in the Bessel beam will depend on the exact location that the beam strikes a given piece. For the purpose of simulating the impact of texture on the Bessel beam, a periodic surface is used so that the effects of amplitude and spatial frequency (the pitch of height deviations) may be seen. A ray-tracing based simulation of these effects is shown in FIG. 31, for a Bessel beam of numerical aperture=0.37 incident on the glass surface.

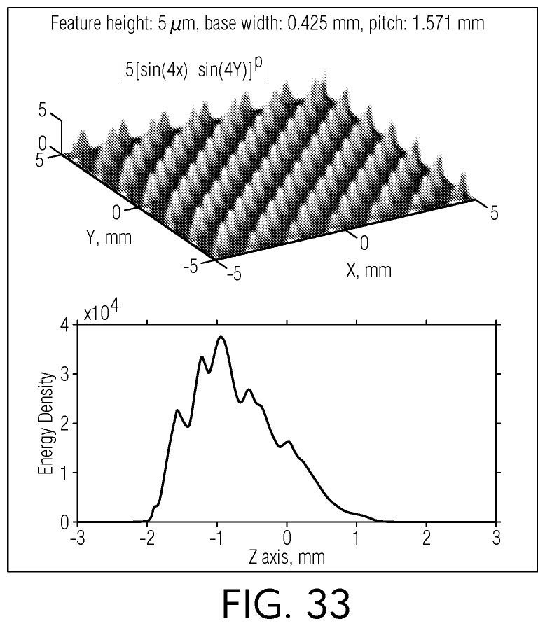

The results of the simulation for two specific amplitudes of surface texture are shown in FIGS. 32 and 33. In both of these cases, the periodicity (pitch) and the shape (base width) of the height distortions was held constant, but the amplitude of the deviations was changed from 0.125 μm to 5 μm. While the smaller height deviations impart a negligible effect on the on-axis intensity profile of a Gauss-Bessel beam in the direction of beam propagation (FIG. 32), it is evident the larger deviations introduce significant distortion and complex structure to the on-axis intensity profile of the Gauss-Bessel beam (FIG. 33).

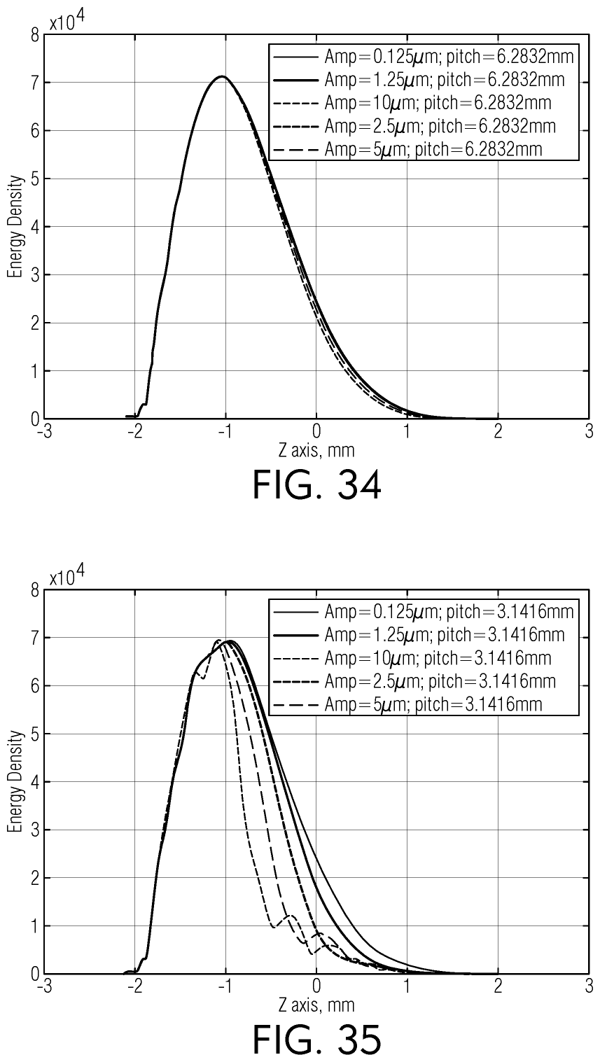

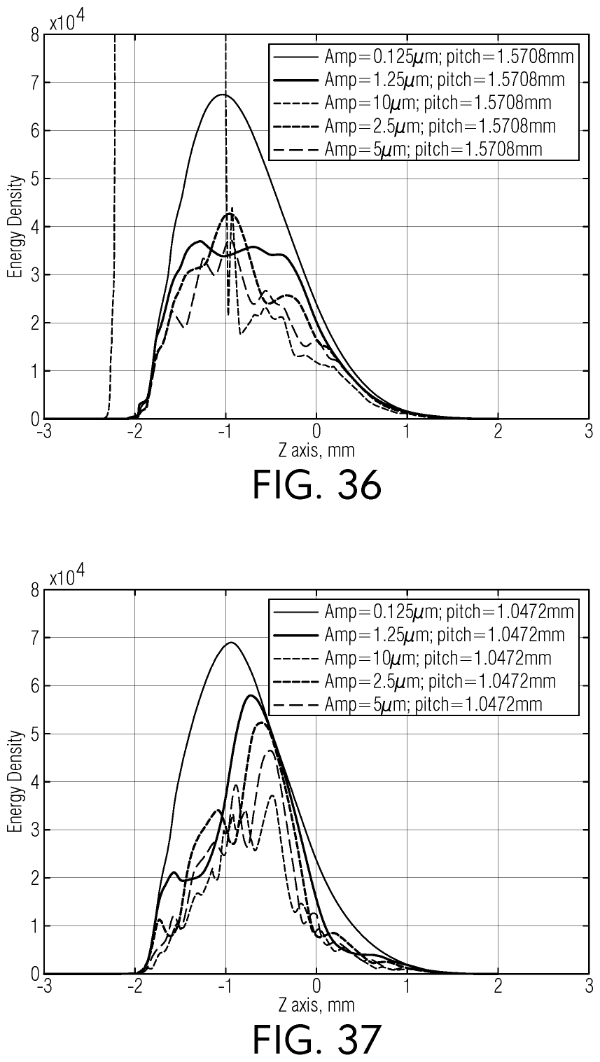

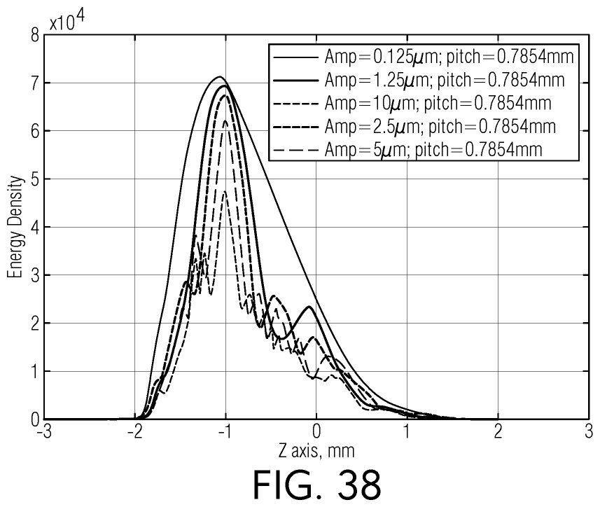

Referring now to FIGS. 34-38, a comparison of the effect of the amplitude and pitch of surface texture on the on-axis intensity profile in the direction of beam propagation of a Gauss-Bessel beam having a numerical aperture of 0.37 is depicted. In all cases, the ratio of the base width of the simulated feature to the pitch was held constant, at a value of 0.27. As can be seen most clearly by looking at the pitch=3.14 mm plot (FIG. 35), the amplitude of the height deviations is a primary driver of Bessel beam distortion. But, the pitch of the height deviations is also important. For the largest pitch (6.28 mm, FIG. 34), the beam remained undistorted for all height amplitudes modeled. The features with pitches of about 1.0-1.6 mm caused the most distortion to this Bessel beam (FIGS. 36 and 37), with the feature pitch of 0.78 mm causing slightly less distortion (FIG. 38). This can be understood by considering the spatial size of the Bessel beam cone interacting with the glass surface, which was about 2 mm in diameter. Hence, for very large pitches, the Bessel beam samples very few surface features, with much of the surface of the samples being flat. As pitch is reduced (i.e., 3.1 mm to 1.6 mm to 1.0 mm), the Bessel beam interacts with more of the surface features, and more distortion is caused. The distortion is random, and will depend on where the Bessel beam is positioned relative to the surface feature pattern. However, when the pitch gets even smaller, the distortion effect becomes less random, as all azimuthal portions of the Bessel cone striking the surface will sample similar surface features. Hence, for the pitch=0.78 mm case, the distortion tends to exhibit a moderately uniform attenuation of the on-axis intensity profile (intensity vs. z) of the Gauss-Bessel beam, with fluctuations that are reduced in amplitude compared to those seen at larger pitches.

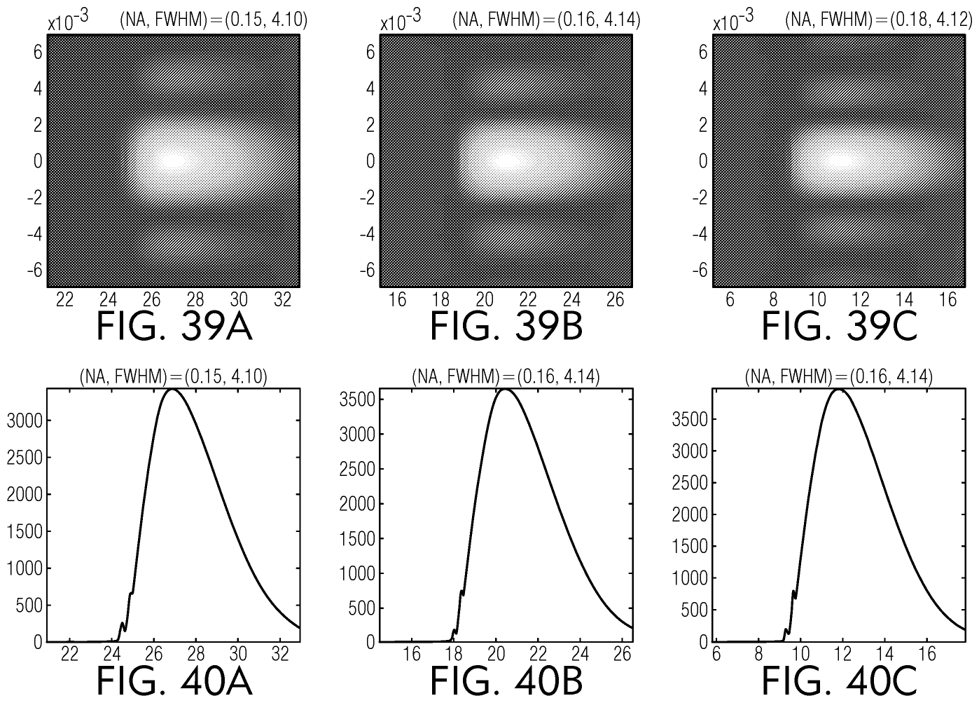

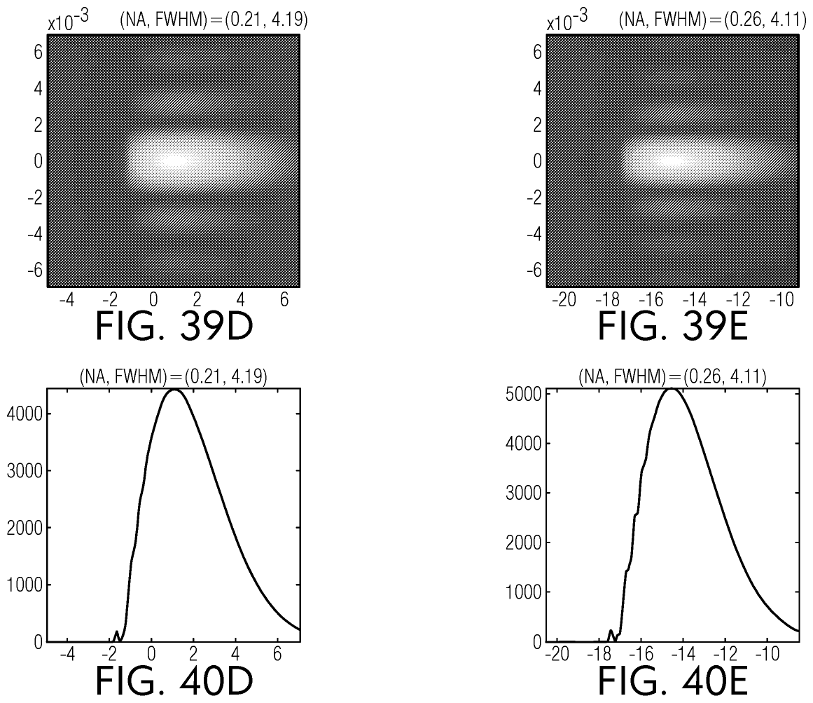

Referring now to FIGS. 39A-39E, 40A-40E, 41A-41E, 42A-42E, 43A-43E, 44A-44E, and 45, the effects of a range of numerical apertures are depicted. FIGS. 39A-39E show a modeled data set of the cross-sectional intensity of a Gauss-Bessel beams vs. propagation distance along the optical axis that comprises beams with a range of numerical apertures (0.15, 0.16, 0.18, 0.21, 0.26) interacting with air (i.e., without any glass substrate). In all cases, the focal line length was held constant, at a value of about 4.1 mm. FIGS. 40A-40E show on-axis intensity profiles of the modeled data of FIGS. 39A-39E, respectively, exhibiting a sharp rise on the left and a slower decay on the right.

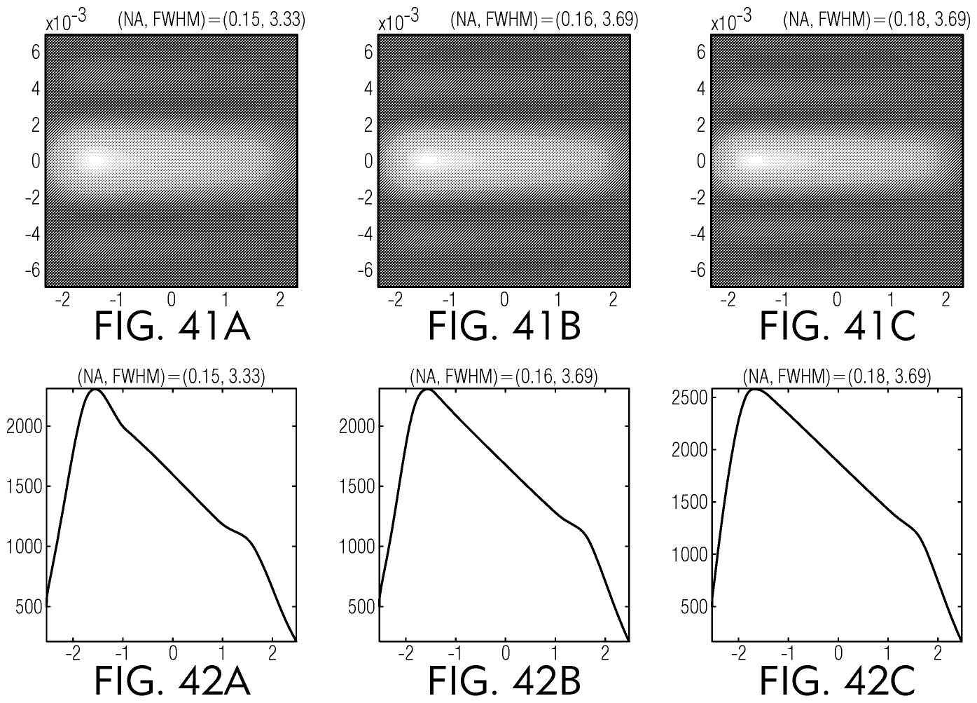

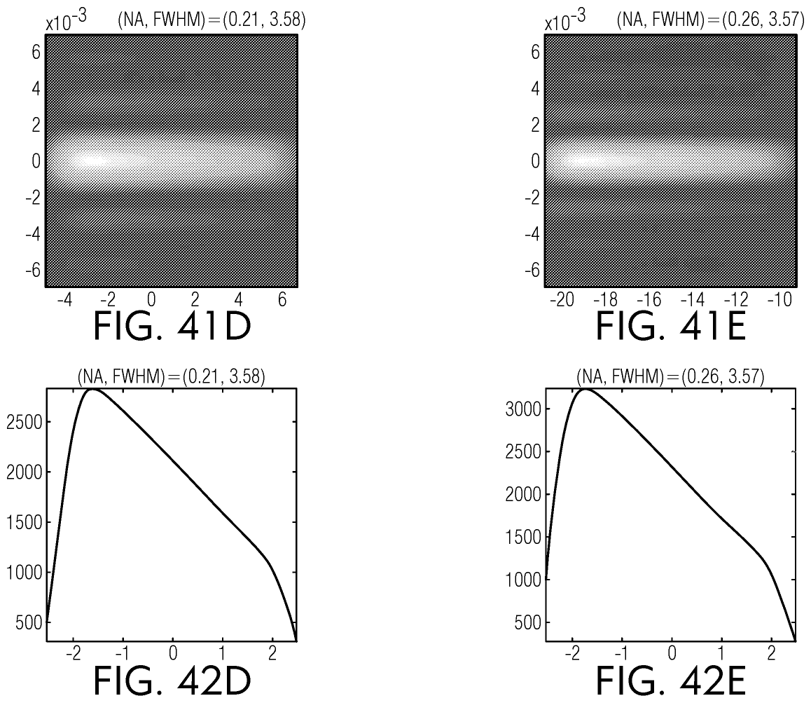

FIGS. 41A-41E show a modeled data set that comprises Bessel beams with the same numerical apertures and focal line length as FIGS. 39A-39E interacting with a flat glass substrate (i.e., surface roughness less than 10 Å), which indicated no significant beam profile distortion caused by the flat glass substrate. FIGS. 42A-42E show on-axis intensity profiles of the modeled data of FIGS. 41A-41E, respectively, where expected on-axis intensity profile of the Gauss-Bessel beam is maintained.

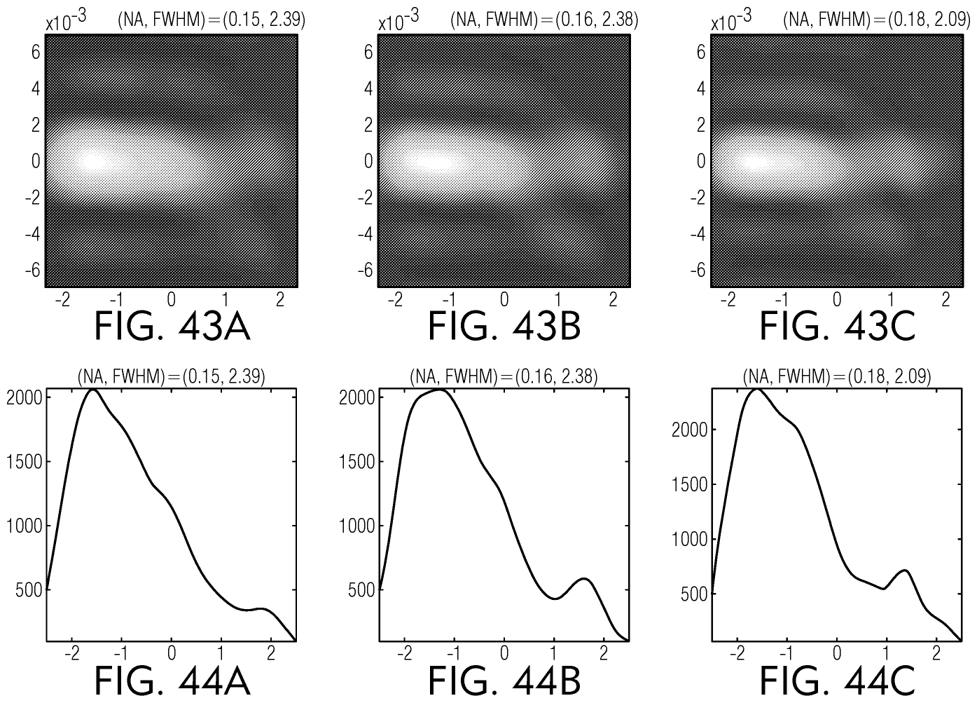

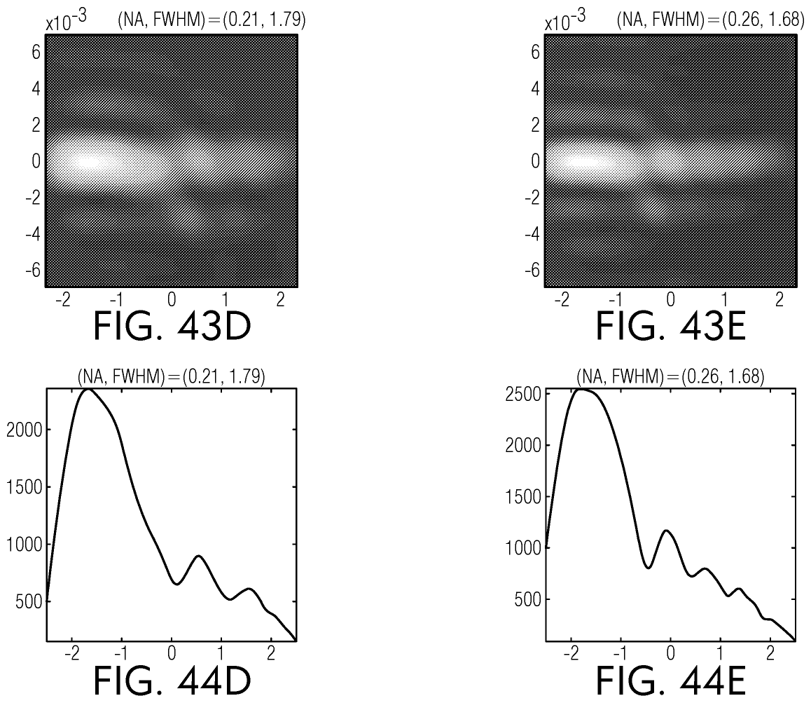

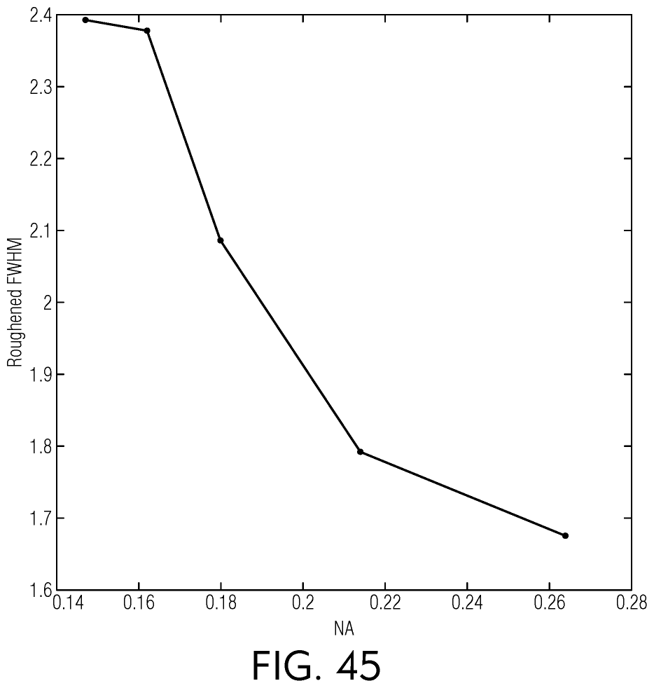

FIGS. 43A-43E show a modeled data set of the cross-sectional intensity of a Gauss-Bessel beams vs. propagation distance along the optical axis that comprises beams with the same numerical apertures and focal line length as FIGS. 39A-39E interacting with a textured glass substrate (i.e., surface roughness greater than 1 μm), indicating that the Bessel beam with the lowest numerical aperture (NA=0.15 in FIG. 43A) had the least beam profile distortion. FIGS. 44A-44E show on-axis intensity profiles of the modeled data of FIGS. 43A-43E, respectively, indicating that the beam with the lowest numerical aperture (NA=0.15 in FIG. 44A) had the least amount of truncation in the expected shape of on-axis intensity profile. FIG. 45 graphically depicts the length of the on-axis intensity profile of the beam as a function of numerical aperture as shown in FIGS. 44A-44E, indicating that a relatively lower numerical aperture results in maintained focal line length. As exemplified by FIGS. 39A-39E, 40A-40E, 41A-41E, 42A-42E, 43A-43E, 44A-44E, and 45, the beams having relatively lower numerical apertures are less distorted by the textured glass substrate.

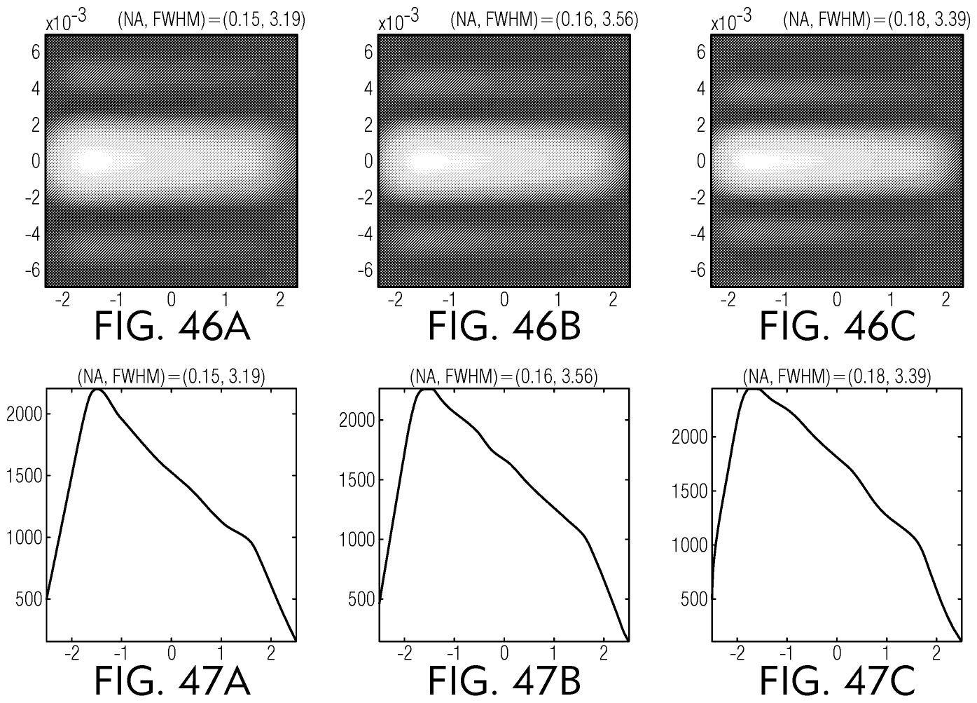

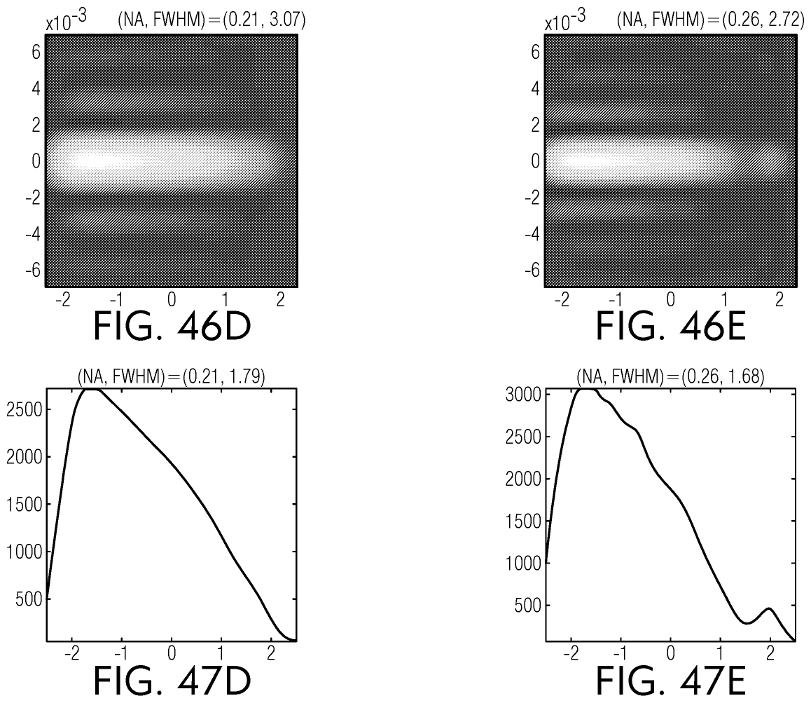

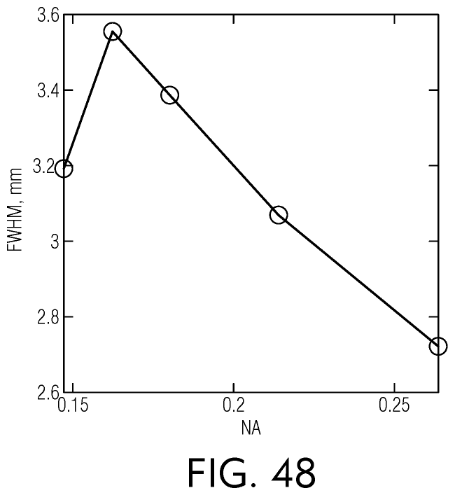

The lateral position at which the Bessel beam interacts with a periodic texture of a glass substrate effects beam cutting. Referring now to FIGS. 46A-46E, 47A-47E, 48, 49A-49E, 50A-50E, 51, 52A-52E, 53A-53E, 54, 55A-55E, 56A-56E, 57, 58A-58E, 59A-59E, and 60, the effects of various spatial periods of textured glass surfaces and a range of numerical apertures is depicted. FIGS. 46A-E show a modeled data set of the cross-sectional intensity of a Gauss-Bessel beams vs. propagation distance along the optical axis that comprises beams with the same numerical apertures and focal line length as FIGS. 39A-39E interacting with a textured glass surface having a height defined by an amplitude of 5 μm*(Sin(2x)+Sin(2y))⁶. FIGS. 47A-47E show on-axis intensity profiles of the modeled data of FIGS. 46A-46E, respectively. FIG. 48 graphically depicts the length of the Gauss-Bessel beam on-axis intensity profile as a function of numerical aperture shown in FIGS. 47A-47E. For the simulated surface textures, the spatial period of the texture is larger than or comparable to the size the ray bundle interacting with the glass surface. This means that the exact lateral position the beam interacts with the periodic texture of the model will matter. To account for this, additional simulations were performed where various lateral offsets of the beam vs. the surface texture were used.

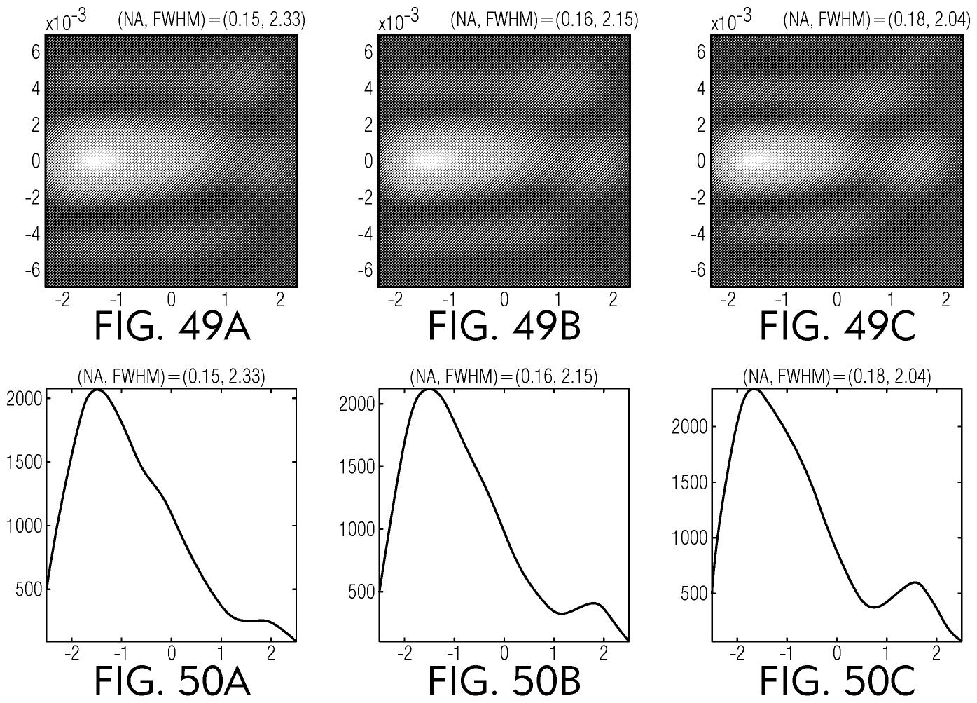

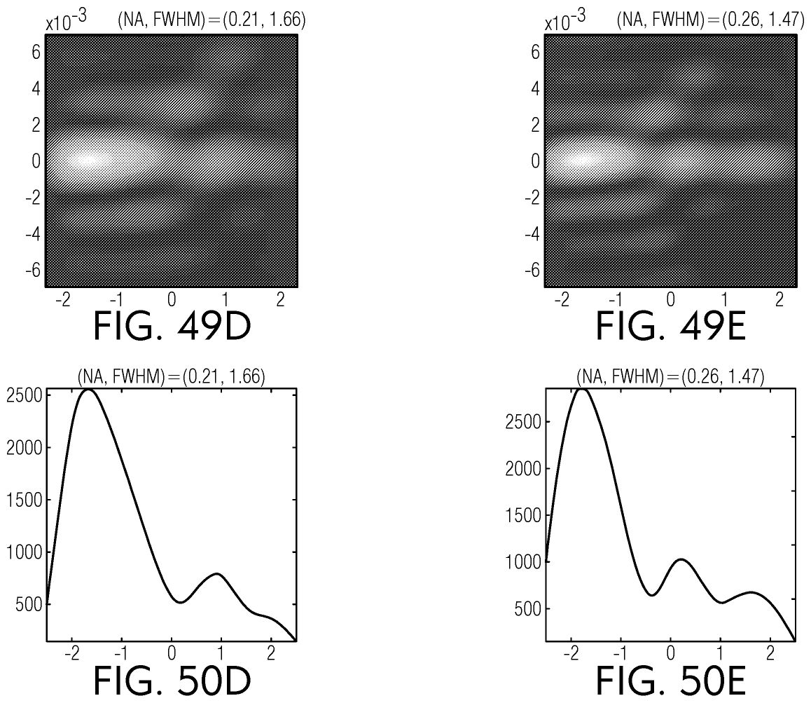

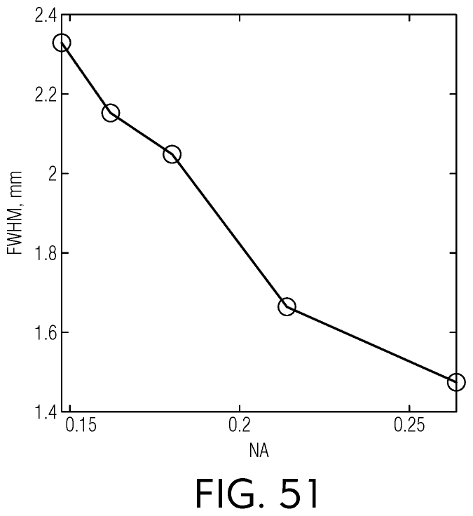

FIGS. 49A-49E show a modeled data set of the cross-sectional intensity of a Gauss-Bessel beams vs. propagation distance along the optical axis that comprises beams with the same numerical apertures and focal line length as FIGS. 39A-39E interacting with a textured glass surface having a height defined by an amplitude of 5 μm*(Sin(2x)+Sin(2y))⁶ laterally offset (i.e., y-shifted) by 1.0 mm. FIGS. 50A-50E show the on-axis intensity profiles of the modeled data of FIGS. 49A-49E, respectively. FIG. 51 graphically depicts the length of the Gauss-Bessel on-axis intensity profile as a function of numerical aperture shown in FIGS. 50A-50E.

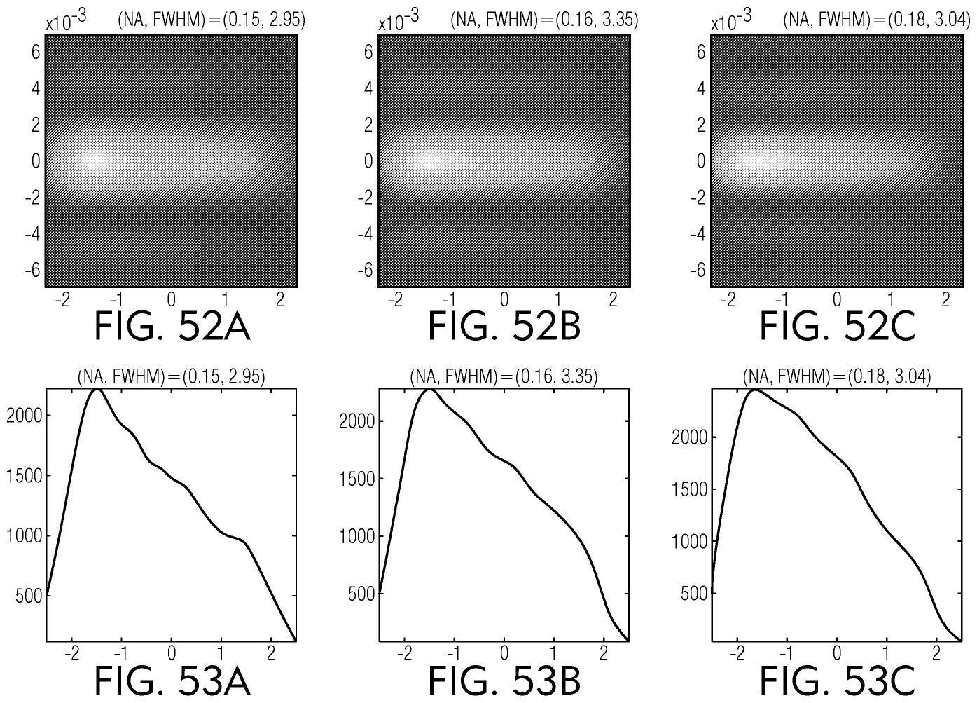

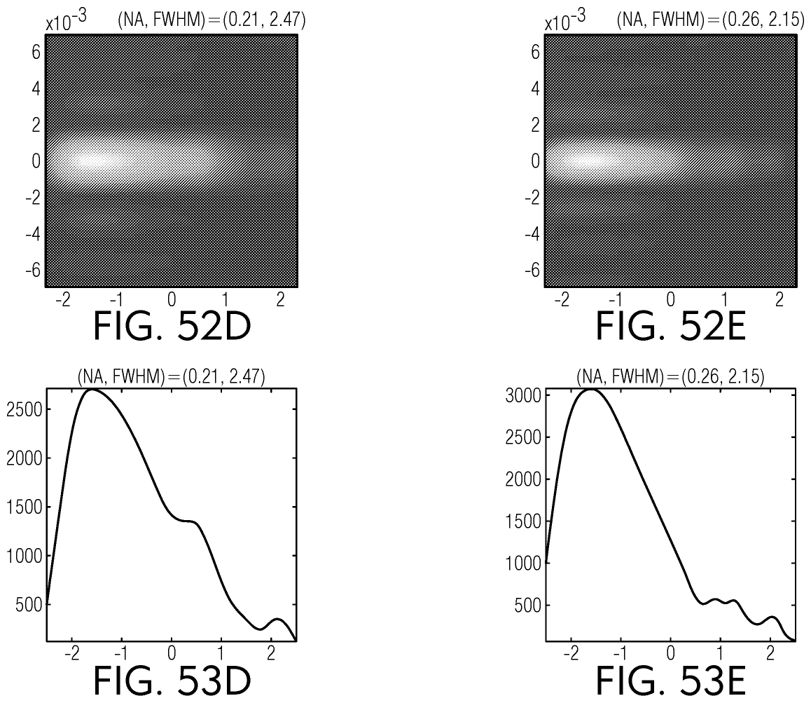

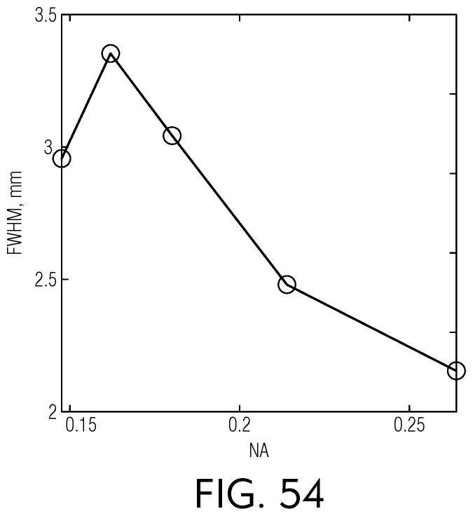

FIGS. 52A-52E show a modeled data set of the cross-sectional intensity of a Gauss-Bessel beams vs. propagation distance along the optical axis that comprises beams with the same numerical apertures and focal line length as FIGS. 39A-39E interacting with a textured glass surface having a height defined by an amplitude of 10 μm*(Sin(2x)+Sin(2y))⁶. FIGS. 53A-53E show the on-axis intensity profiles of the modeled data of FIGS. 52A-52E, respectively. FIG. 54 graphically depicts the length of the Gauss-Bessel on-axis intensity profile as a function of numerical aperture shown in FIGS. 53A-53E.

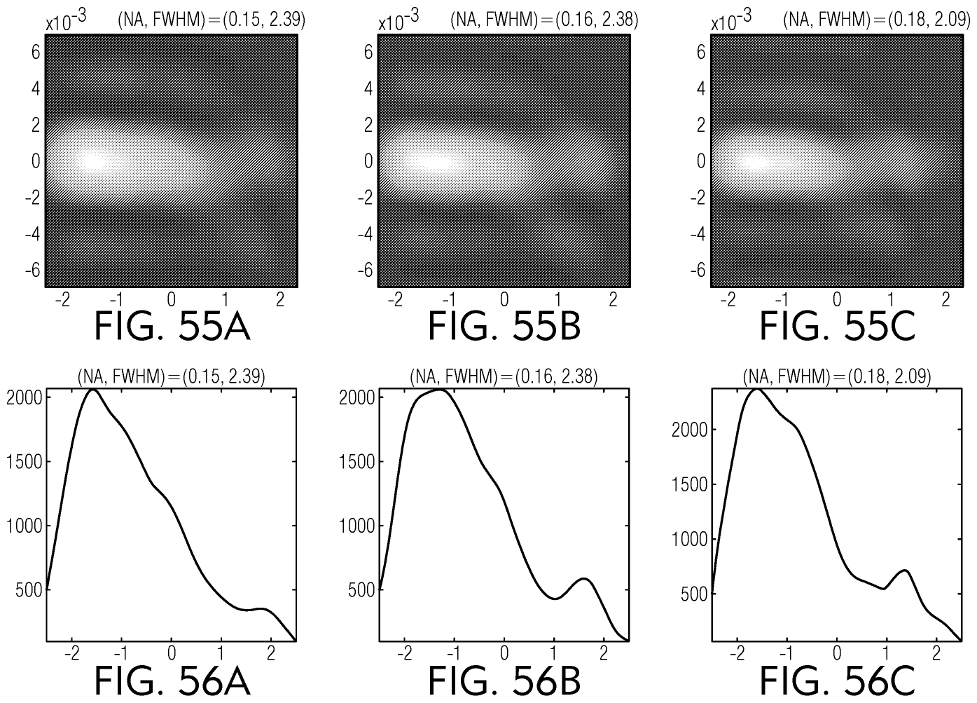

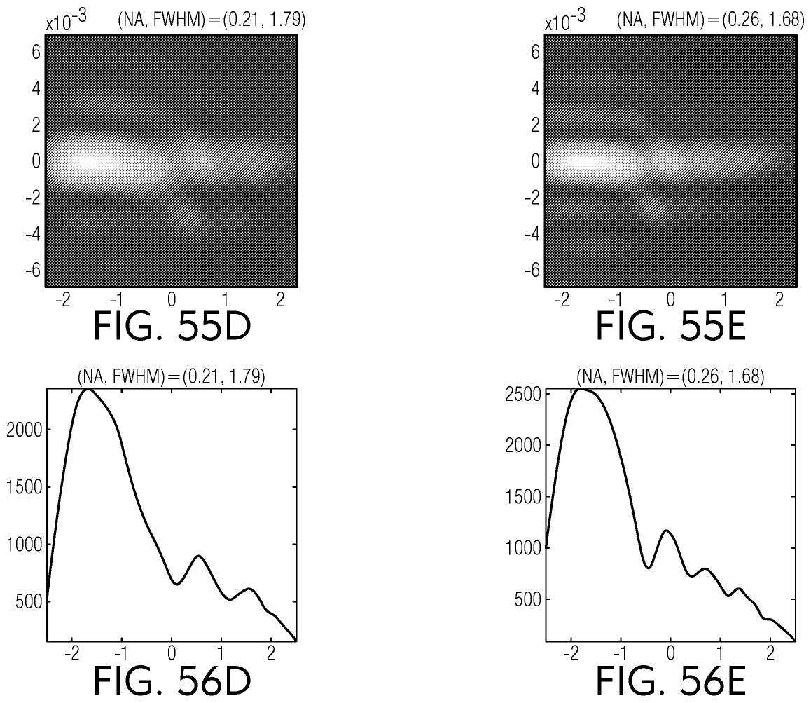

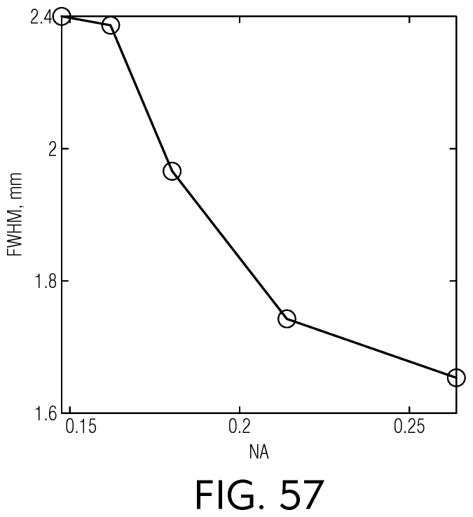

FIGS. 55A-55E show a modeled data set of the cross-sectional intensity of a Gauss-Bessel beams vs. propagation distance along the optical axis that comprises beams with the same numerical apertures and focal line length as FIGS. 39A-39E interacting with a textured glass surface having a height defined by an amplitude of 10 μm*(Sin(2x)+Sin(2y))⁶ laterally offset (i.e., y-shifted) by 0.35 mm. FIGS. 56A-56E show the on-axis intensity profiles of the modeled data of FIGS. 55A-E, respectively. FIG. 57 graphically depicts the length of the Gauss-Bessel on-axis intensity profile as a function of numerical aperture shown in FIGS. 56A-56E.

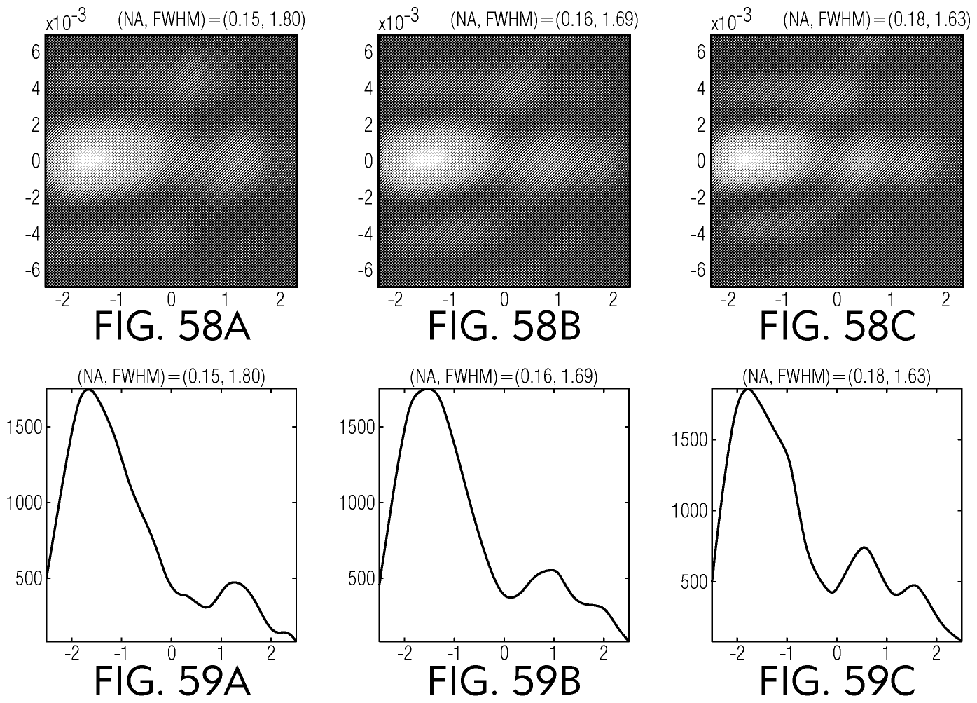

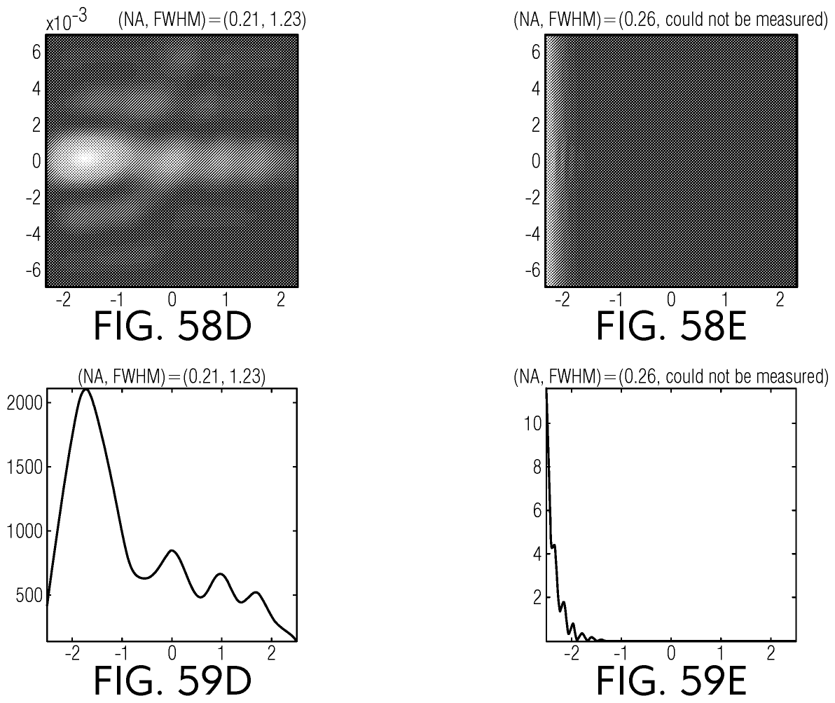

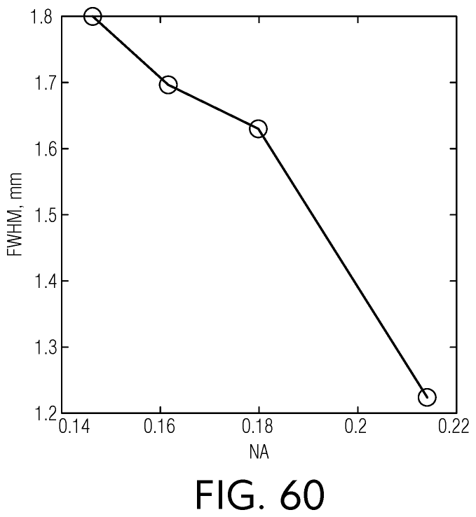

FIGS. 58A-58E show a modeled data set of the cross-sectional intensity of a Gauss-Bessel beams vs. propagation distance along the optical axis that comprises beams with the same numerical apertures and focal line length as FIGS. 39A-39E interacting with a textured glass surface having a height defined by an amplitude of 10 μm*(Sin(2x)+Sin(2y))⁶ laterally offset (i.e., y-shifted) of 1.0 mm. FIGS. 59A-59E show the on-axis intensity profiles of the modeled data of FIGS. 58A-F, respectively. FIG. 60 graphically depicts the length of the Gauss-Bessel intensity profile as a function of numerical aperture shown in FIGS. 59A-59E.

As exemplified by FIGS. 46A-46E, 47A-47E, 48, 49A-49E, 50A-50E, 51, 52A-52E, 53A-53E, 54, 55A-55E, 56A-56E, 57, 58A-58E, 59A-59E, and 60, the Gauss-Bessel beams having relatively lower numerical apertures are less distorted by the various spatial periods of the textured glass substrate.

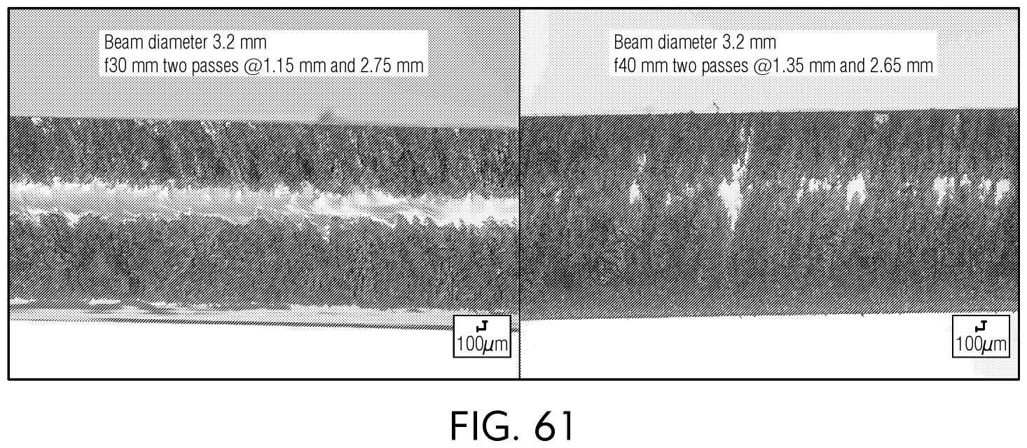

Referring now to FIG. 61, work was done to cut textured material with Bessel beams at two numerical apertures, 0.37 (f=30 mm lens) and 0.28 (f=40 mm lens) using the optical system described above in connection with Table 1. A high energy psec pulsed laser was used to cut and was capable of delivering about 160 W at 110 kHz or about 1.5 mJ/burst to the substrate. In both cases, use of a single pass would not create nano-perforations of sufficient length within the glass to fully perforate the material. Hence, multiple passes were then attempted at different focus heights. The two images in FIG. 61 show the results for each numerical aperture, with two passes used and with focus adjusted to attempt to achieve maximum coverage within the substrate. For the numerical aperture=0.37 (30 mm lens), only 70-75% of the material nano-perforated. For the numerical aperture=0.28 (40 mm lens), the coverage was more complete, within nano-perforations able to reach about 1.75 mm or about 60% of the substrate thickness with a single pass. With two passes at different focus heights the nano-perforation may extend through the entire depth of the substrate, but with small discontinuous regions evident. These regions may be caused by the nano-perforation beam being distorted by local surface features, which vary spatially across the substrate.

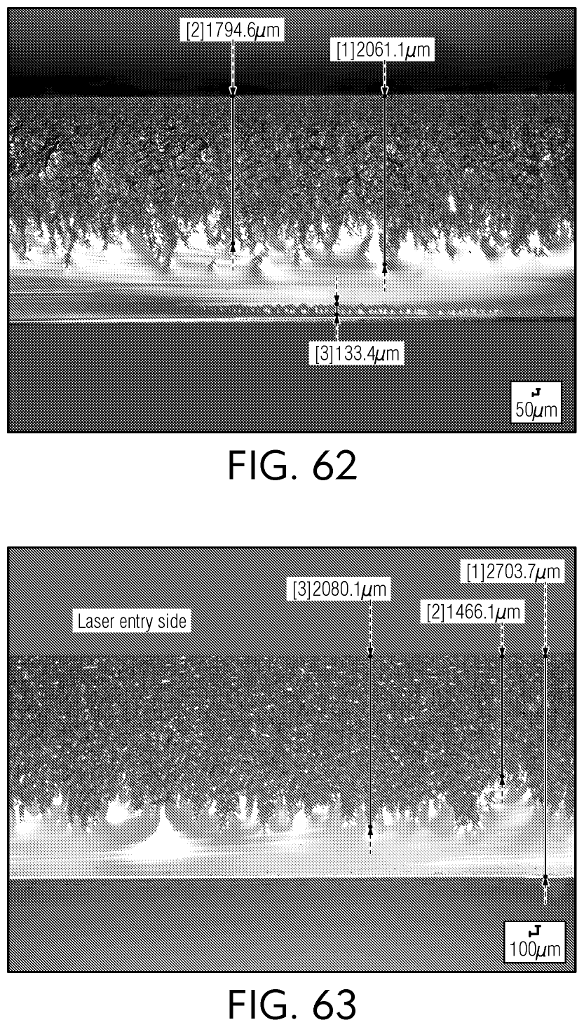

Referring now to FIGS. 62 and 63, optical systems as described in Table 1 that produce beams with lower numerical aperture were also evaluated, employing the same laser and burst energies used for FIG. 61. Single-pass nano-perforated samples using 50 mm (numerical aperture=0.22) and 58 mm lenses (numerical aperture=0.19), respectively, are shown. In both cases, the nano-perforations failed to form near the bottom side of the sheet. The nano-perforations now extend on average to 2 mm, or about 75% of the glass thickness. It may be seen that, on average, nano-perforation penetrates slightly deeper in the case when the beam with numerical aperture=0.19 was used.

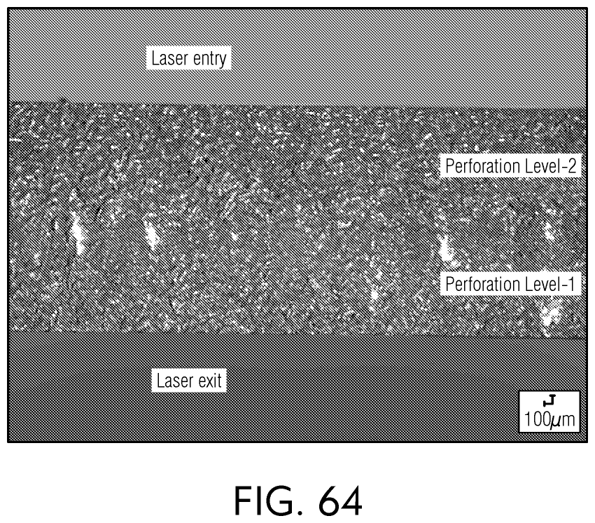

Referring now to FIG. 64, two passes at different focus heights using the beam with numerical aperture=0.19 were used to cut the glass sheet. The nano-perforations extended throughout the full thickness of the glass sheet, with reduced discontinuous regions compared to those seen when cutting with a beam having a numerical aperture=0.28.

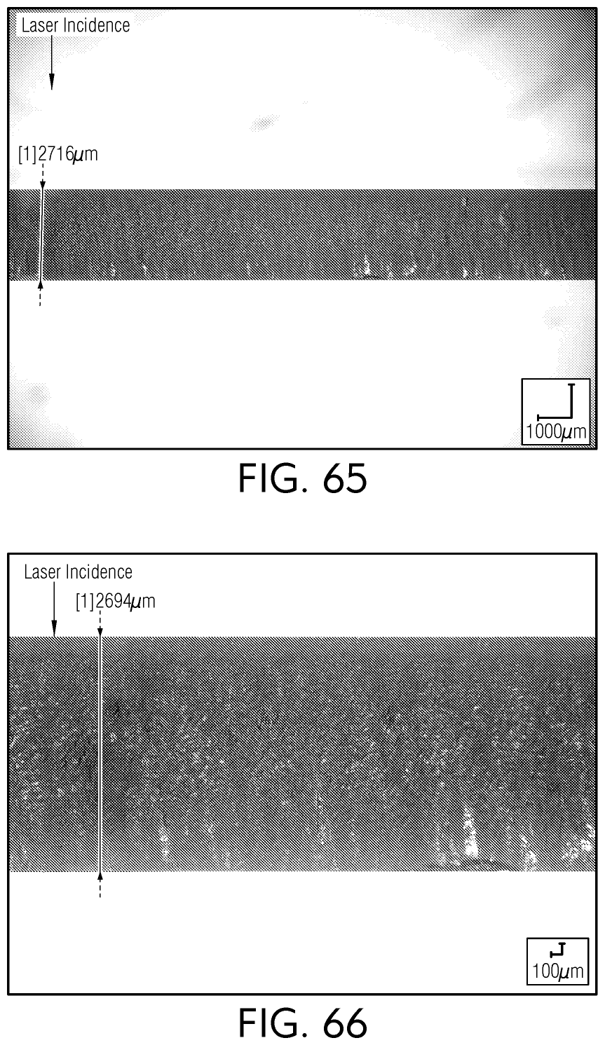

Referring now to FIGS. 65 and 66, work was done to cut a 2.75 mm thick textured glass substrate with a Bessel beam using a 58 mm lens (numerical aperture=0.19), 2.3 mm focal line length, and a 1.5 μJ/burst to the substrate using the optical system described above in connection with Table 1. As shown, the use of the lower numerical aperture resulted in most of the cut edge including uniform nano-perforations that penetrated the full thickness of the textured glass substrate.

A consideration for using a lower numerical aperture is the increase in the core diameter of the focal line and focal line length, both of which may reduce the beam intensity. If the intensity is reduced too much, then the focal line may no longer be able to modify the glass. But, since a Bessel beam's length may be independently controlled by changing the size of the beam entering the axicon, a reduction in input beam size may be used to shorten the focal line and, thus, increase the intensity. This ability for Bessel beams to vary length of the focal line independent of the core diameter is an important degree of freedom when cutting transparent substrates with Bessel beams in non-linear processes.

Another consideration when using a Bessel beam with a lower numerical aperture is that laser energy no longer flows into the focal line from rays directed at high angles. The ability of energy to flow in from the sides and cause a Bessel beam core (central lobe) to (re)form downstream from shadowing elements is an effect referred to as “self-healing” and enables restoration of the intensity of the central lobe following interruption by a shadowing element. Hence, if there are shadowing effects occur from debris on the substrate surface, or from the plasma created by the laser-material interaction, then when Bessel beams with lower numerical aperture are used for cutting, self-healing may not occur and the penetration depth of nano-perforations formed in the substrate is limited. In practice, it has been experimentally observed that when the numerical aperture of a Bessel beam is less than about 0.10, the ability of Bessel beams to reliably form deep nano-perforations in glass and glass ceramic materials is significantly impaired. The preferred numerical aperture range for cutting of textured or curved (including 3D) surfaces with Bessel beams may be from 0.10<NA<0.25, or 0.12<NA<0.23, or 0.15<NA<0.20.

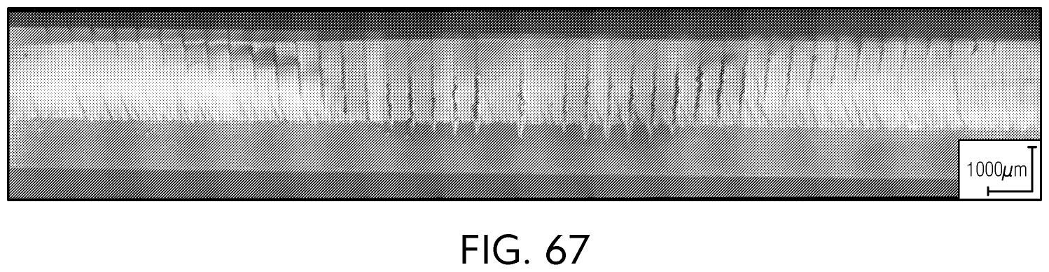

Regarding surface tilt, when a Bessel beam converges and strikes a piece of glass, the rays are refracted at the air-glass interface. If the Bessel beam is propagating normal to the glass surface, then this refraction is uniform azimuthally around the optical axis of the beam. The Bessel beam will be lengthened along the optical axis by this refraction, but it will still focus to a Bessel profile inside the glass—making a core with high intensity that ultimately creates the “nano-perforation”. However, when a Bessel beam is incident on tilted piece of glass, aberrations are induced upon refraction at the surface because the azimuthal symmetry is broken—in other words, rays on one side of the converging beam are incident on the glass surface at different angles than the other side of the beam. As shown in FIG. 67, a series of nano-perforations are made into a thick piece of polished glass, where the angle of the nano-perforation is incrementally changed from −20° to 20° in 1° increments from left to right in the figure. At higher angles, the length of the nano-perforation drastically reduces.

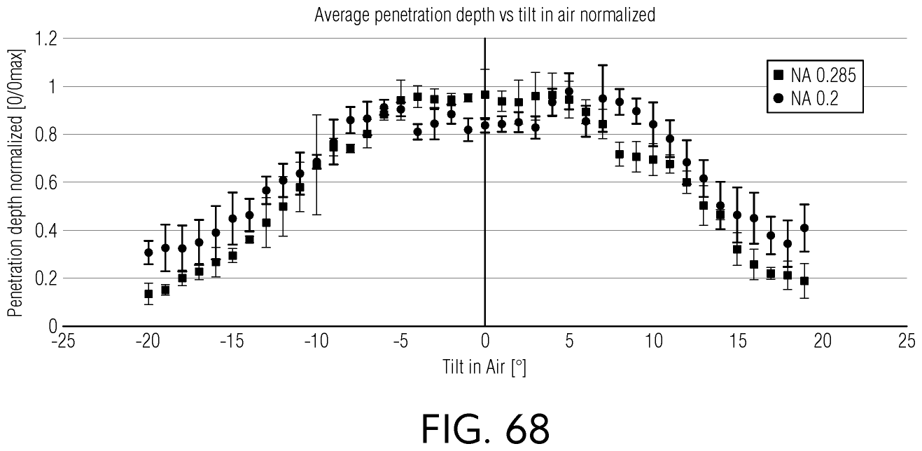

Referring now to FIG. 68, a quantification of the test described for FIG. 67 is given. FIG. 68 compares test results for Bessel beams having NA=0.19 (f=58 mm lens) and NA=0.28 (f=40 mm lens) using the optical system described above in connection with Table 1. The depth of the nano-perforation from each beam was measured for each substrate tilt angle at 1° increments from −20° to 20°. The results show that when using the Bessel beam with numerical aperture=0.19, the length of the nano-perforation is maintained over a wider range of angles. Hence, the numerical aperture plays a role in tolerance to air-glass surface aberrations.

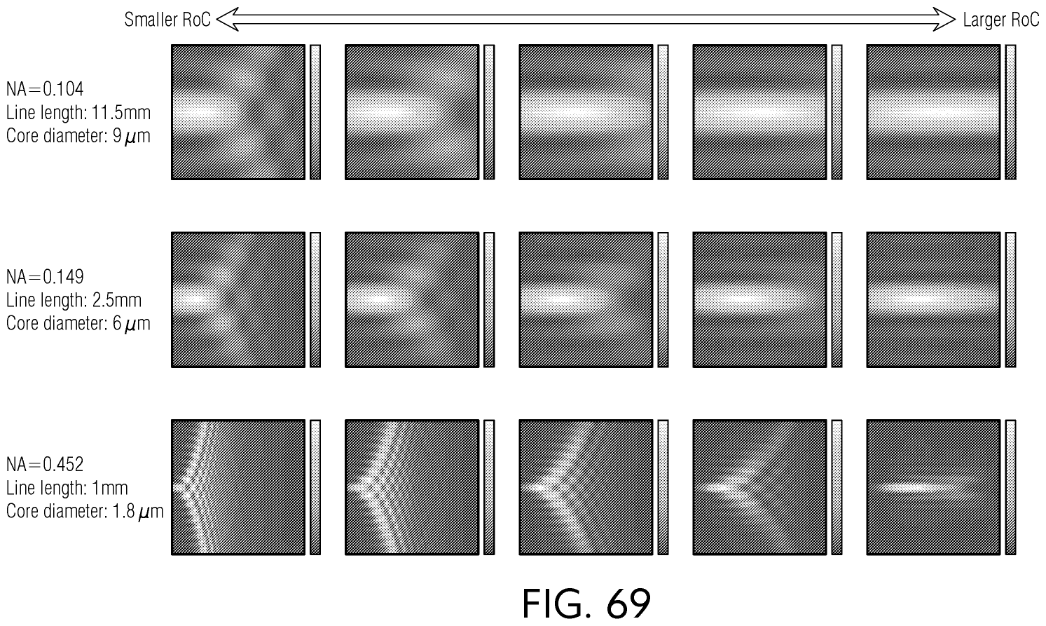

Bessel beam numerical aperture plays a role not just in tolerance to the tilt of the substrate, but also to tolerance to the surface of the glass being curved. Such curvature may be encountered when glass is used to form non-planar products, such as cover glass for handheld electronics with curved edges, augmented or virtual reality headsets, or for glass tubing. FIG. 69 shows a modeled set of data that compares Bessel beams with a range of NAs (0.104, 0.149, 0.452) interacting with a range of surface curvatures ranging from 5 mm (tight radius) to 200 mm (large radius). The Bessel beams become more aberrated when numerical aperture increases, radius of curvature decreases, or depth into the substrate increases.

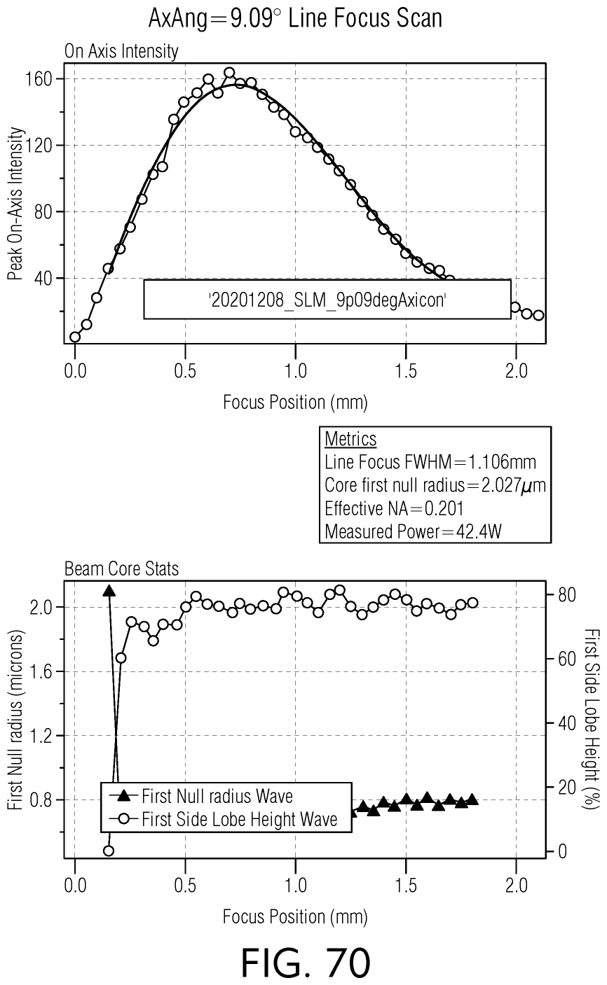

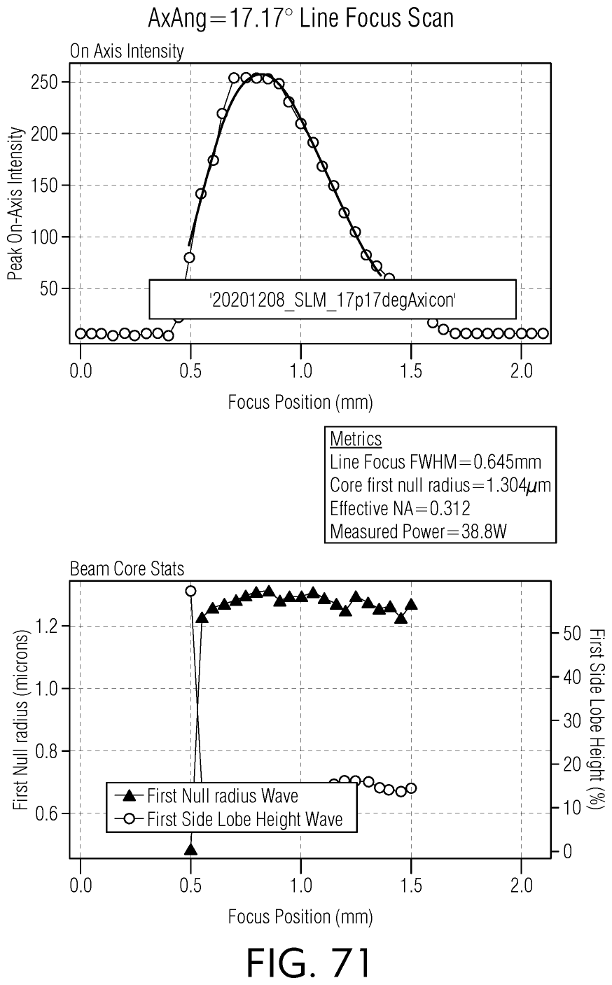

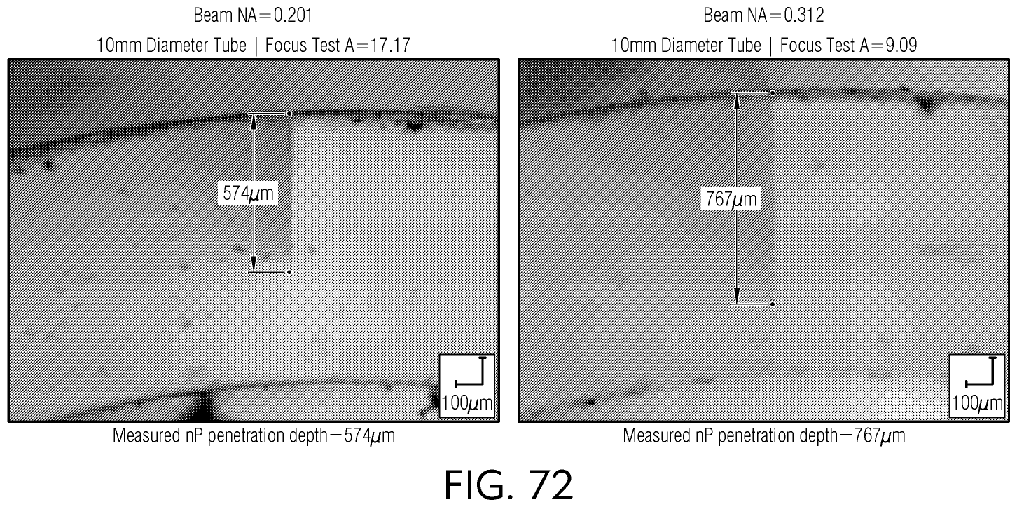

Referring now to FIGS. 70-72, examples were run using a Bessel beam with two different numerical apertures to nano-perforate 10 mm diameter (5 mm radius of curvature) Pyrex glass tubing. A 1064 nm pulsed laser (about 10 psec pulses, 8 pulses/burst) was used, providing an energy incident on the substrate of about 400 μJ/burst. A spatial light modulator was used as an adjustable axicon. The beam numerical apertures produced by the spatial light modulator were 0.20 and 0.31, with beam measurements of the focal line shown in FIGS. 70 and 71. Cross sections of the nano-perforated glass tubing are shown in FIG. 72. Focus adjustments were made to find the conditions that produced the deepest nano-perforations for each beam. With three tests performed per beam NA (not all depicted), the beam with NA=0.20 NA provided an average perforation depth of ˜766 μm (767, 767, 764 μm), whereas the beam with NA=0.31 provided an average perforation depth of 504 μm (574, 460, 478 μm). Hence the lower NA beam produced deeper nano-perforations in the presence of the curved surface, despite the fact that its energy density was lower due to its larger core diameter and longer line length.

The method of cutting textured glass articles described herein enables high edge quality, and high precision, laser cutting of glass and glass ceramics that are formed through a rolling process. This is despite the fact that such rolled materials have significant surface texture, which tends to distort and scatter the laser beam doing the cutting. In particular, the method allows the laser beam to create laser modification sites, or nano-perforations, through the full depth or thickness of the glass sheet. This means the full benefit of low sub-surface damage laser cutting may be realized for textured glasses. Only small amounts of grind and polish (e.g., less than 30 μm) may be required to reach high strength. These nano-perforations define the cleaving or crack propagation plane within the glass sheet. Without this definition through the full thickness of the sheet, the crack may deviate and the edge of the cut will not precisely follow the intended path, forming “cantilever curl”, which may extend about 100 to 150 μm from the cut edge, necessitating additional grinding of the part in final finishing.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A method of processing a transparent workpiece, the method comprising:
directing a defect-forming laser beam to an impingement surface of a transparent workpiece, the defect-forming laser beam having a numerical aperture from 0.10 to 0.25, the transparent workpiece having a textured surface, the textured surface having an Ra value of greater than or equal to 0.5 μm.

2. The method of claim 1, wherein the defect-forming laser beam forms a laser beam focal line within the transparent workpiece, the laser beam focal line forming a defect in the transparent workpiece.

3. The method of claim 1, wherein the defect-forming laser beam is quasi-non-diffracting.

4. The method of claim 1, wherein the defect-forming laser beam is a Gauss-Bessel beam.

5. The method of claim 1, wherein a defect formed by the defect-forming laser beam extends through the entire thickness of the transparent workpiece.

6. The method of claim 5, wherein the thickness of the transparent workpiece is greater than or equal to 1.0 mm.

7. The method of claim 5, wherein the thickness of the transparent workpiece is greater than or equal to 3.0 mm.

8. The method of claim 1, wherein the textured surface has an Ra value of greater than or equal to 2.0 μm.

9. The method of claim 1, wherein the impingement surface of the transparent workpiece is curved.

10. A method of separating a transparent workpiece, the method comprising:
directing a defect-forming laser beam to a curved impingement surface of a transparent workpiece, the defect-forming laser beam having a numerical aperture from 0.10 to 0.25.

11. The method of claim 10, wherein the defect-forming laser beam forms a laser beam focal line within the transparent workpiece, the laser beam focal line forming a defect in the transparent workpiece.

12. The method of claim 11, wherein the length of the laser beam focal line is greater than or equal to the thickness of the transparent workpiece.

13. The method of claim 10, wherein the defect-forming laser beam is quasi-non-diffracting.

14. The method of claim 10, wherein the defect-forming laser beam is a Gauss-Bessel beam.

15. The method of claim 10, wherein a defect formed by the defect-forming laser beam extends through the entire thickness of the transparent workpiece and the thickness of the transparent workpiece is greater than or equal to 1.0 mm.

16. The method of claim 10, wherein the curved impingement surface is a textured surface, the textured surface having an Ra value of greater than or equal to 0.5 μm.

17. The method of claim 10, wherein a defect formed by the defect-forming laser beam extends through the entire thickness of the transparent workpiece.

18. A glass article in an as-cut condition, the glass article comprising:
a textured surface having a Ra value greater than or equal to 0.5 μm;
a second surface spaced apart from the textured surface by a thickness, the thickness greater than or equal to 500 μm; and
an edge extending from the textured surface and the second surface, the edge comprising a cantilever curl, the cantilever curl extending a distance less than 150 μm from the edge.

19. The glass article of claim 18, wherein the thickness is greater than or equal to 1.0 mm.

20. The glass article of claim 18, wherein the edge has sub-surface damage less than or equal to 30 μm.
